(19) United States
(12) Patent Application Publication
(10) Pub. No.: US 2015/0331917 A1
(43) Pub. Date: Nov. 19, 2015

(54) RECORDING MEDIUM HAVING STORED THEREIN TRANSMISSION ORDER DETERMINATION PROGRAM, TRANSMISSION ORDER DETERMINATION DEVICE, AND TRANSMISSION ORDER DETERMINATION METHOD

(71) Applicant: Fujitsu Limited, Kawasaki-shi (JP)

(72) Inventors: Toshihiro SHIMIZU, Sagamihara (JP); Takeshi Yasuie, Kawasaki (JP)

(21) Appl. No.: 14/672,413

(22) Filed: Mar. 30, 2015

(30) Foreign Application Priority Data
May 13, 2014 (JP) 2014-099426

(51) Int. Cl. G06F 17/30; H04L 29/06; H04L 29/08

(52) U.S. Cl. CPC G06F 17/30563; H04L 67/10; G06F 17/30345; G06F 17/30312; H04L 67/42

(57) ABSTRACT

A computer obtains communication information that is transmitted/received between tiers in an information processing system providing a result of a process performed in an n-th (n>2) tier in reply to received request, identifies pairs of the request and corresponding response in each of the plurality of tiers from the obtained communication information, compares the pairs in each of tiers, extracts an order relationship wherein the request of a second pair is transmitted after the response of a first pair is obtained, obtains the order relationship in an (n-i)th tier on the basis of the order relationship between the pairs in an (n-i+1)th tier that respectively correspond to the pairs in the (n-i)th tier, sequentially from the n-th tier to a first tier, and determines a transmission order of the request to the information processing system on the basis of the obtained order relationship.

### CROSS-REFERENCE TO RELATED APPLICATION

This application is based upon and claims the benefit of priority of the prior Japanese Patent Application No. 2014-099426, filed on May 13, 2014, the entire contents of which are incorporated herein by reference.

### FIELD

The embodiments discussed herein are related to a technology for determining a transmission order.

### BACKGROUND

Computer systems using recent ICT (information and communications technology) often have large-scale and complicated configurations. As an example, an increasing number of a variety of business services, such as payment or transfer processing in online banking, are provided in Web-based three-tier systems configured of a Web server, an application server, and a database (DB) server. These systems have large-scale and complicated configurations due to business efficiency, security measures or the like. In addition, immediacy is requested for many business services, and the stoppage of services or the deterioration in response is a problem. Therefore, grasping in detail of an operation status and the prompt resolution of performance problems for a large-scale system are desired.

Further, in a complicated system (e.g., a Web-based three-tier system) in which a plurality of applications operate in cooperation, the performance of the entirety of a system in addition to behaviors of respective servers is desired to be observed and analyzed in order to investigate the causes of performance deterioration and a failure. In a Web-based three-tier system, for example, a processing request to the application server is sometimes generated in response to a processing request to the Web server. The same applies to the application server and the DB server. A processing call relationship between applications as described above is used to examine repercussions of a performance problem in the system.

In view of the foregoing, the following technologies have been proposed as a system analyzing method for analyzing an operation mode of a network to which a plurality of servers are connected by using a computer.

As a first technology, a technology for executing a test of a man-machine function in a client-server system has been proposed (for example, Patent Document 1). In the first technology, test pattern generating means is incorporated into at least one client of a plurality of clients, and generates a test pattern including operation procedure and display information for a response test that have been operation-input by using a man-machine function of the client. The generated test pattern is stored in a test pattern file. Test executing means is incorporated into each of the clients, and executes response simulation tests to the clients and servers by using the test pattern file and the operation procedure and the display information that the test pattern stored in the test pattern file indicates. Test result collecting means collects test results of the response simulation tests executed in the respective clients.

As a second technology, a technology for executing a performance evaluating test has been proposed (for example, Patent Document 2). In the second technology, a computer obtains a first packet and a second packet transmitted to a first device. The computer transmits a third packet which is a copy of the first packet except for its destination (the destination is replaced with a second device), on the basis of the obtained first packet. When a time period that is equal to a time interval between the obtainment of the first packet and the obtainment of the second packet has passed after the transmission of the third packet, the computer transmits a fourth packet in which a destination of the second packet has been set to be the second device, on the basis of the obtained second packet.

As a third technology, a telegram message recording apparatus has been proposed for example (for example, Patent Document 3). The telegram message recording apparatus is capable of executing a reproduction test of an occurrence of a failure by performing retransmission at the same timing as an actual distribution interval, and of performing efficient simulation by performing high-speed retransmission at short telegram message intervals for a portion that does not need to be faithfully reproduced.

As a fourth technology, a technology has been proposed for supporting the automatic designing of a linkage system that is capable of performing a highly efficient linkage process in the linkage of transactions (for example, Patent Document 4). As an example, in a system in which processing is advanced while messages are exchanged between multi-layer servers, such as electronic commerce, the messages are often exchanged using, as a key, a character string that associates a message such as a request ID. Further, different ID character strings may be used between respective layers such as a Web server or an application server. When monitoring behavior of a system, or analyzing a request delay problem, a process of putting together related requests (a linkage process) is performed at a high speed by using the ID character strings as clues, and a route and a timing through or at which a specific request is transmitted are analyzed. In the fourth technology, a linkage supporting apparatus that supports a linkage process for linking related messages from among a plurality of messages transmitted and received between a plurality of communication terminals includes an information acquisition unit, an unneeded character string exclusion unit, and a processing order determination unit. The information acquisition unit acquires respective message types of the plurality of messages, character strings that are respectively included in the plurality of messages, and amounts of data flow when the character strings are transferred. The unneeded character string exclusion unit excludes character strings that are not needed as keywords in the linkage process from among the plurality of character strings acquired by the information acquisition unit, on the basis of the information acquired by the information acquisition unit. The processing order determination unit determines an order of using, in the linkage process, each of the plurality of character strings from which the character strings have been excluded by the unneeded character strings exclusion unit, on the basis of the information acquired by the information acquisition unit.

Patent Document 1: Japanese Laid-open Patent Publication No. 9-244913

Patent Document 2: Japanese Laid-open Patent Publication No. 2011-199680

Patent Document 3: Japanese Laid-open Patent Publication No. 2010-81194

Patent Document 4: Japanese Laid-open Patent Publication No. 2009-238069

Patent Document 5: Japanese Laid-open Patent Publication No. 2006-011683

Patent Document 6: Japanese Laid-open Patent Publication No. 3-240137

### SUMMARY

A transmission order determination program according to one aspect of the embodiments causes a computer to execute the following process. The computer obtains communication information that is transmitted/received between tiers in an information processing system constructed of a plurality of tiers, the information processing system providing a result of a process performed in an n-th (n>2) tier in reply to received request information. The computer identifies pairs of the request information and response information corresponding to the request information in each of the plurality of tiers from the obtained communication information, compares the pairs in each of the plurality of tiers, and extracts an order relationship wherein the request information of a second pair is transmitted after the response information of a first pair is obtained. The computer obtains the order relationship in an (n-i)th (i=1, 2, . . . , n-1) tier on the basis of the order relationship between the pairs in an (n-i+1)th tier that respectively correspond to the pairs in the (n-i)th tier, sequentially from the n-th tier to a first tier. The computer determines a transmission order of the request information to the information processing system on the basis of the obtained order relationship.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining an access reproduction technology between a client and a server.

FIG. 2A and FIG. 2B are diagrams explaining the adjustment of a timing of access reproduction.

FIG. 3A and FIG. 3B are diagrams explaining the settlement of an access transmission order that enables comparison verification between the contents of requests.

FIG. 4 is a diagram explaining the determination of an access reproduction timing according to an embodiment.

FIG. 5 illustrates an example of a transmission order determination device according to the embodiment.

FIG. 6 illustrates an example of a timing determination device according to the embodiment.

FIG. 7 illustrates an example of a multi-tier system on which access reproduction is performed according to the embodiment.

FIG. 8 is a diagram explaining an example of a constraint on a timing of transmitting a message between tiers according to the embodiment.

FIG. 9 is a diagram explaining an example of a constraint on a timing of transmitting a message between tiers in a case in which there are a plurality of servers in the same tier, according to the embodiment.

FIG. 10 illustrates the entire processing flow according to the embodiment.

FIG. 11 illustrates details of a flow (S2) of extracting a partial-order relationship between pairs of a request and a response transmitted between tiers according to the embodiment.

FIG. 12 illustrates the content of capture data used in the embodiment.

FIG. 13 is a diagram explaining a process (S11) of extracting a partial-order relationship between pairs of a request transmitted to the (n-i+1)th tier and a response received from the (n-i+1)th tier in the (n-i)th tier according to the embodiment.

FIG. 14 is a diagram explaining the extraction of a partial-order relationship between queries for updating a region (table) in a DB according to the embodiment.

FIG. 15 is a diagram explaining the extraction of an order relationship between a reference query and an update query in the DB according to the embodiment.

FIG. 16 is a diagram explaining the composition of a plurality of partial-order relationships according to the embodiment.

FIGS. 17A and 17B illustrate details of a flow of determining a constraint in a higher tier on the basis of a constraint in a lower tier according to the embodiment.

FIG. 18 illustrates an example of shortening an access reproduction time on the basis of a constraint according to the embodiment.

FIG. 19 is a diagram explaining a case in which a request issuing order in a higher tier is changed in order to satisfy a constraint in a lower tier according to the embodiment.

FIG. 20 illustrates a flow of a process of extracting a constraint in a DB tier, which is included in the process of S13 according to the embodiment (Example 1).

FIG. 21 is a diagram explaining the extraction of a partial-order relationship in a case of updating a table in the DB according to the embodiment (Example 1).

FIG. 22 is a diagram explaining an order relationship between a reference query and an update query to the DB according to the embodiment (Example 1).

FIG. 23 illustrates a flow (S31) of extracting a partial order relating to an update query according to the embodiment (Example 1).

FIG. 24 illustrates a flow (S32) of extracting a partial-order relationship between a reference query and an update query to the same table according to the embodiment (Example 1).

FIG. 25A to FIG. 25C illustrate an example of setting a partial-order relationship between a reference query and an update query to the same table according to the embodiment (Example 1).

FIG. 26A and FIG. 26B are diagrams explaining the division of data based on an order relationship according to the embodiment (Example 1).

FIG. 27 illustrates a flow of determining a request issuing timing according to the embodiment (Example 2).

FIG. 28 illustrates an example of a configuration block diagram of a hardware environment of a computer that executes a program according to the embodiment.

### DESCRIPTION OF EMBODIMENTS

The following method is given as an example of a verification method using an access reproduction device. In this verification method, the access reproduction device obtains a communication message, such as a request message or a response message, that is transmitted/received between devices included in a normally operating system. The access reproduction device obtains a response message in reply to a request message that has been transmitted on the basis of the obtained communication message in a system that is operating in an environment different from the operation environment of the normally operating system. The access reproduction device compares the obtained message with the response message, and verifies whether the same operation as the operation performed in the normally operating system is performed in the system that is operating in the different environment, by using the comparison result.

Transmission messages include a message for which a transmission order needs to be considered on the basis of another message, and a message for which the transmission order does not need to be considered. Messages constructed from obtained packets do not include information relating to the transmission order, and therefore the messages are transmitted in the obtaining order of the messages.

However, in the verification method above, a processing time equivalent to the processing time in the normally operating system environment is taken. As an example, when a process in the system operating in the different environment can be distributed in parallel, it is difficult to transmit the message for which the transmission order needs to be considered to the same apparatus, and to transmit the message for which the transmission order does not need to be considered to a different apparatus, because there is no information relating to the transmission order.

As a method for estimating the transmission message for which the transmission order needs to be considered and the transmission message for which the transmission order does not need to be considered, a method using a constraint on an access order is considered. In verification in a single tier, for example, between a Web server and a DB server, a transmission message for which sequentiality needs to be considered can be estimated by using the constraint on the access order.

However, in a multi-tier system including, for example, a client, a Web server, and a DB server, it is not sufficient to only consider an access order for respective tiers, and transmission or reception in one tier may be influenced by transmission or reception in another tier.

One aspect of the embodiments discussed herein is related to a technology that enables transmission of request information taking into consideration the order in a plurality of tiers in a multi-tier information processing system.

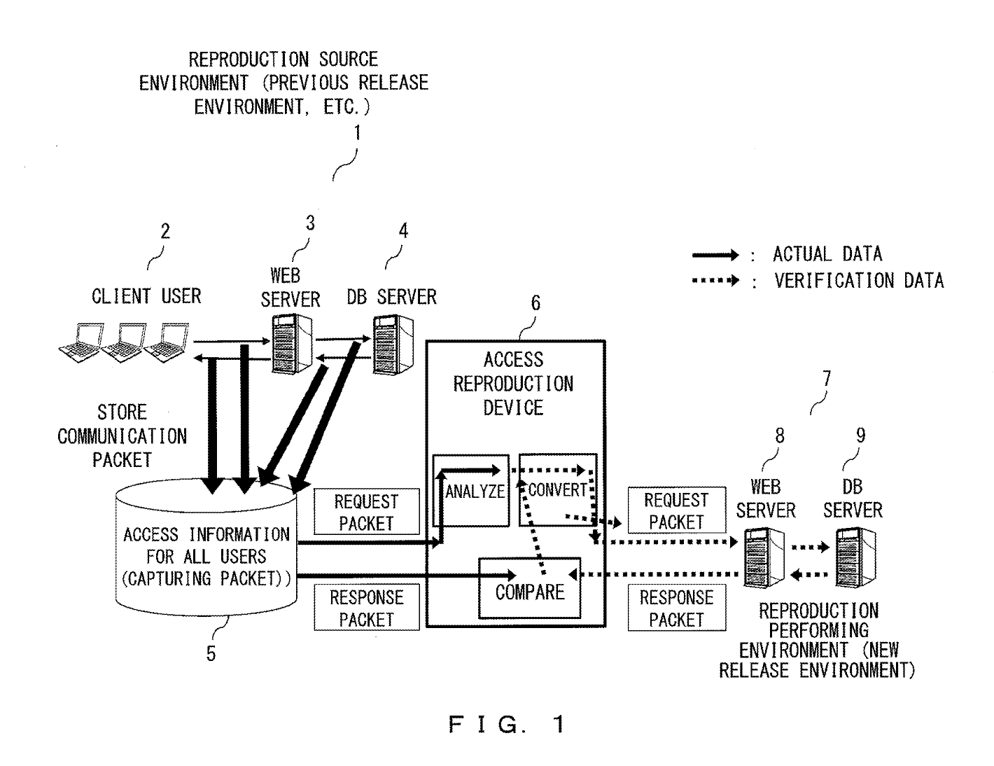

FIG. 1 is a diagram explaining an access reproduction technology between a client and a server. FIG. 1 illustrates a case in which an existing system such as a previous release environment (reproduction source environment 1) is reproduced in a new environment (reproduction performing environment 7) such as a new release environment.

As an example, a case is assumed in which a Web server 3 and a data (DB) server 4 provide a service in cooperation in reply to a request from a client device (hereinafter referred to as a “client”) 2.

First, in the reproduction source environment 1, a request (for example, a message based on the HyperText Transfer Protocol (HTTP)) is transmitted from the client 2 to the Web server 3. Then, the Web server 3 issues a query based on the request to the DB server 4.

The DB server 4 transmits a result of the query to the Web server 3. Upon receipt of a query execution result from the DB server 4, the Web server 3 transmits the query execution result to the client 2. A series of processes in a system (the Web server, the application (AP) server, the DB server, and the like) from the execution of a process based on a request from a client to the transmission of a result of the process to the client as described above are referred to as a transaction.

As described above, communication packets such as a request packet or a response packet are communicated between the client 2 and the Web server 3 and/or between the Web server 3 and the DB server 4. The communication packets are collected in a packet collecting device (not illustrated), and are stored as access information in a storage device 5 (packet capturing). Records of the communication packets as described above (capture data) are collected for the respective clients 2.

An access reproduction device 6 obtains a packet of the capture data, analyzes information (a session ID, the date and time, an IP address, a port number, and the like) that is peculiar to a system in header information of the packet, and converts the peculiar information so as to adapt to the reproduction performing environment 7. As a result, a difference between system environments can be absorbed.

As an example, when the request packet stored in the storage device 5 is input, the access reproduction device 6 analyzes the request packet (actual data), and converts information peculiar to a system in the reproduction source environment 1 into information peculiar to a system in the reproduction performing environment 7. The access reproduction device 6 outputs the converted request packet (verification data) to the reproduction performing environment 7 that is constructed of a Web server 8 and a DB server 9.

In the reproduction performing environment 7, the Web server 8 and the DB server 9 perform processing similarly to the Web server 3 and the DB server 4, and the Web server 8 transmits a response packet including a processing result to the access reproduction device 6.

The access reproduction device 6 compares the response message (verification data) that has been transmitted from the reproduction performing environment 7 with a response message (actual data) of the capture data, and confirms the processing result. This allows a verification of whether the reproduction source environment 1 can be reproduced in the reproduction performing environment 7.

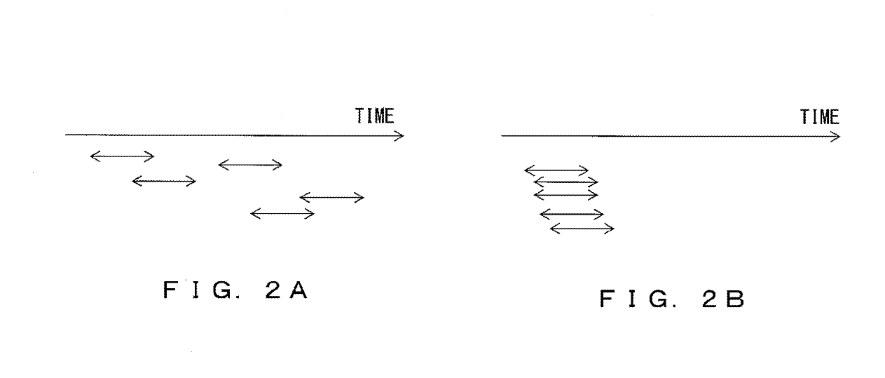

In the access reproduction technology described above, a change in an access reproduction timing such as the advancement of a data transmission timing, as illustrated in FIG. 2A and FIG. 2B, is requested in some cases in order to reduce a test time or to execute a load test.

FIG. 2A and FIG. 2B are diagrams explaining the adjustment of an access reproduction timing. In FIG. 2A and FIG. 2B, a left-side end of a line segment expressed by a bidirectional arrow indicates a timing of issuing a request message (e.g., an HTTP request). A right-side end of the line segment expressed by the bidirectional arrow indicates a timing of receiving a response message (e.g., an HTTP response). Here, a “message” is the smallest unit of data that a plurality of devices communicate on the basis of a prescribed protocol. As an example, a request using the HTTP or a corresponding response, or a request using the Internet Inter-ORB Protocol (IIOP) or a corresponding response corresponds to the “message”.

In access reproduction, it is assumed that the access reproduction timing is changed, for example, from the state illustrated in FIG. 2A of an access timing to the state illustrated in FIG. 2B by advancing data transmission timings.

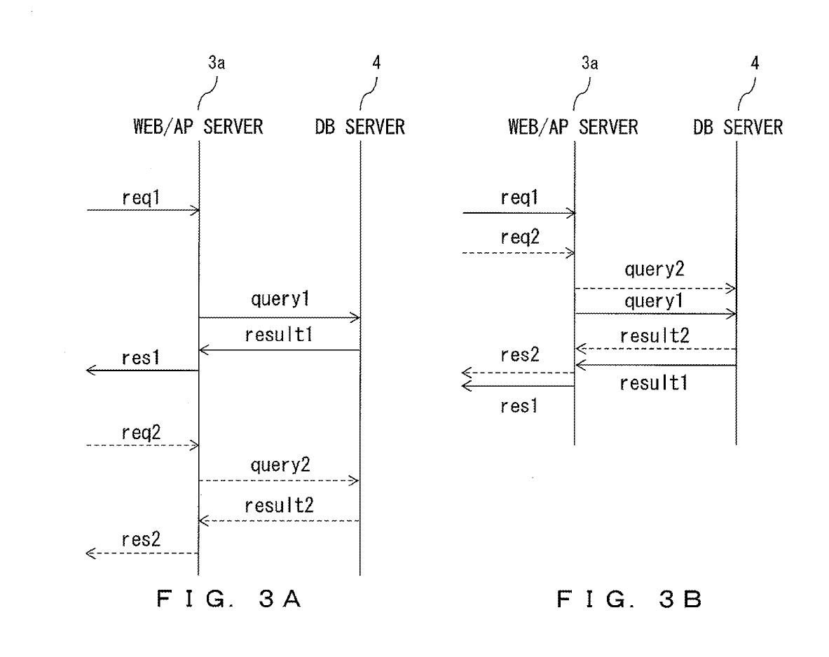

The change in the access timing as described above is constrained in a case in which a Web server transmits a request by using data that is included in a response received from a DB server or the like, or in other cases, or is influenced by a change in the order of access to the DB. The influence on the change in the access timing is further described with reference to FIG. 3A and FIG. 3B.

FIG. 3A and FIG. 3B are diagrams explaining the settlement of an access transmission order that enables comparison verification between the contents of requests. Hereinafter, a request may be referred to as a “req”, and a response may be referred to as a “res”. A query from the Web server or/and the AP server (WEB/AP server) to the DB server may be referred to as a “query”. A result that the DB server transmits in reply to the query from the WEB/AP server to the DB server may be referred to as a “result”. Further, “n” is given to a message included in a transaction n (n: integer).

FIG. 3A illustrates an example of time-series communication of requests and responses when a plurality of transactions are continuously performed in a Web-based two-tier system or a Web-based three-tier system.

The following is performed in a transaction 1. When a request 1 (req1) is transmitted from a client 2, a WEB/AP server 3a issues a query 1 (query) to the DB server 4. The DB server 4 transmits a result 1 (result1) in reply to the query1. Upon receipt of the result1, the WEB/AP server transmits a response 1 (res1) to the client.

The following is performed in a transaction 2. When a request 2 (req2) is transmitted from a client 2, the WEB/AP server 3a issues a query 2 (query2) to the DB server 4. The DB server 4 transmits a result 2 (result2) in reply to the query2. Upon receipt of the result2, the WEB/AP server 3a transmits a response 2 (res2) to the client 2.

When the req2 does not use data of the res1, it is assumed that the req2 is changed so as to be issued without awaiting the res1, as illustrated in FIG. 3B. In other words, it is assumed that the transaction 2 is started before the transaction 1 is finished.

In this case, in an information processing system including a plurality of tiers (hereinafter referred to as a “multi-tier system”), a result of a response may be changed as a result of a change in a processing order in any one of the plurality of tiers. In other words, when the order of the query1 and the query2 is changed as illustrated in FIG. 3B, the contents of the res1 and the res2 may be changed. As an example, in a case in which the query1 is an update query and the query2 is a reference query, when the order of the query1 and the query2 is changed as illustrated in FIG. 3B, the contents of the result1 and the result2 may be different from the contents of the result1 and the result2 in the case illustrated in FIG. 3A. In a case in which updating is performed in reply to both the query1 and the query2 and the same data is changed, a result may be different.

In a method for determining a reproduction timing in an existing system, reproduction is performed at the same timing as the timing at the time of observation, or a reproduction time is determined without considering other tiers. However, result comparison fails to be performed in the latter case.

In view of the foregoing, according to the embodiment, a technology is provided for determining a transmission order of request transmission in access reproduction by incorporating an order constraint in another tier into an order constraint in a target tier.

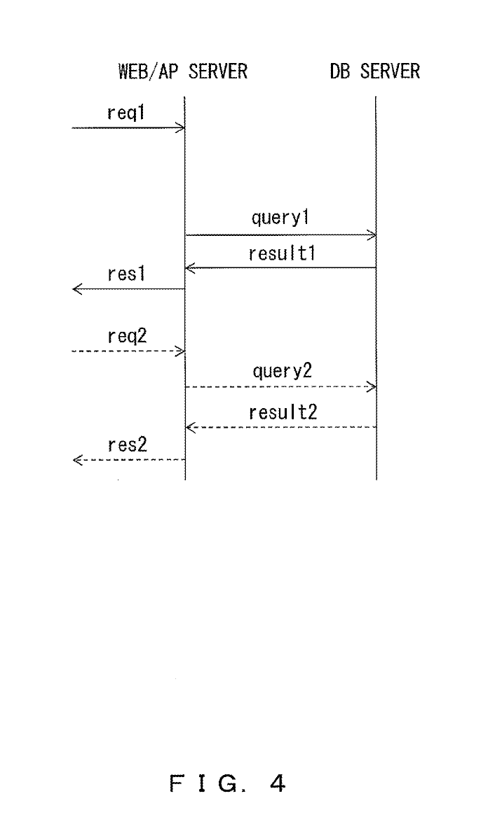

FIG. 4 is a diagram explaining the determination of an access reproduction timing according to the embodiment. In the embodiment, access reproduction is performed such that a change in the order of a request and a response does not influence a processing result. In the example of FIG. 4, in order that the query2 is not transmitted earlier than the query 1 is, a constraint whereby the req2 is not transmitted until the res1 is received is extracted, and a timing is determined on the basis of the constraint.

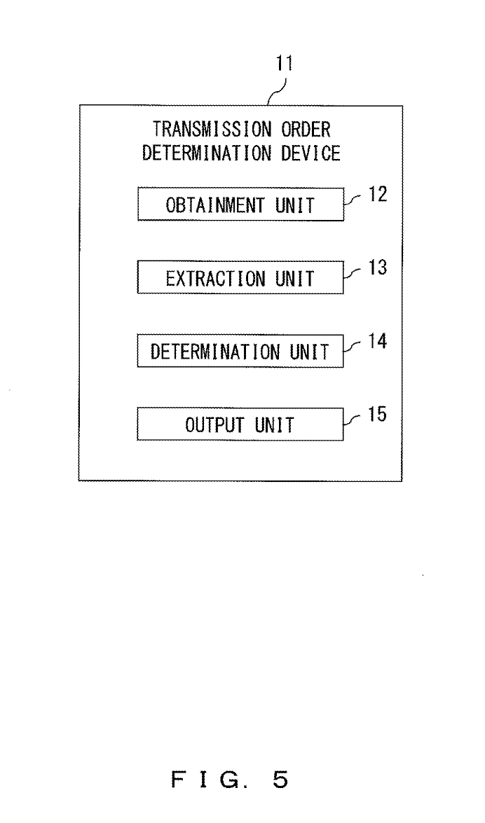

FIG. 5 illustrates an example of a transmission order determination device according to the embodiment. A transmission order determination device 11 includes an obtainment unit 12, an extraction unit 13, and a determination unit 14. As an example of the transmission order determination device 1, a timing determination device 21 is given as described later.

The obtainment unit 12 obtains communication information that is transmitted or received between tiers in an information processing system that provides a result of a process performed in the n-th (n>2) tier in accordance with received request information and that is constructed of multiple tiers. As an example of the obtainment unit 12, a constraint extraction unit 23, which performs the process of S1 as described later, is given.

The extraction unit 13 identifies pairs of request information and response information corresponding to the request information in respective tiers from the obtained communication information. The extraction unit 13 compares the pairs in the respective tiers, and extracts an order relationship in which request information of the second pair is transmitted after response information of the first pair is obtained. As an example of the extraction unit 13, the constraint extraction unit 23, which performs the process of S2 as described later, is given.

The determination unit 14 extracts the order relationship in the (n-i)th (i=1, 2, . . . , n-1) tier on the basis of the order relationship between pairs in the (n-i+1) th tier that respectively correspond to pairs in the (n-i)th tier, sequentially from the n-th tier to the first tier. The determination unit 14 determines a transmission order of request information to the information processing system on the basis of the extracted order relationship. As an example of the determination unit 14, the constraint extraction unit 23, which performs the process of S3 as described later, is given.

The configuration above enables the transmission of request information taking into consideration an order in a plurality of tiers in access reproduction in a multi-tier system. A transaction relating to the updating of a system can be clarified by associating a request and a response over tiers, and therefore which request and response have a dependency on the transaction is clarified. As a result, a change in a request transmission timing (shortening of intervals, or order changing) is performed. In addition, a dependency between transactions is clarified, and therefore an independently reproducible transaction can be divided. As a result, parallel execution using a plurality of access reproduction devices can be performed. In addition, access reproduction of a desired portion can be performed.

When the n-th tier is a tier in which data has been stored, the extraction unit 13 extracts an order relationship from pieces of request information that requests the updating of the same data region in the n-th tier. As an example of this process, the process of S31, which is performed by the constraint extraction unit 23 as described later, is given.

In the configuration above, an issuing order can be set to be an order constraint between queries for updating the same table in a DB.

When the n-th tier is a tier in which data has been stored, the extraction unit 13 does not set an order of continuous pieces of reading request information from among pieces of reading request information that requests reading from the same data region in the n-th tier. As an example of this process, the process of S32, which is performed by the constraint extraction unit 23 as described later, is given.

The configuration above enables queries that access the same table to be classified into queries for performing updating and queries for not performing updating, and enables the queries for not performing updating between the queries for performing updating to not be put in order.

When pairs to be compared in the (n-i)th tier have the order relationship, the determination unit 14 extracts the order relationship between the pairs in the (n-i)th tier in accordance with the order relationship between pairs in the (n-i+1)th tier that respectively correspond to the pairs in the (n-i)th tier. As an example of this process, the process of S23, which is performed by the constraint extraction unit 23 as described later, is given.

When pairs to be compared in the (n-i)th tier do not have the order relationship, but when pairs in the (n-i+1)th tier that respectively correspond to the pairs in the (n-i)th tier have the order relationship, the determination unit 14 extracts the order relationship between the pairs in the (n-i)th tier in accordance with the order relationship between the pairs in the (n-i+1)th tier. As an example of this process, the process of S26, which is performed by the constraint extraction unit 23 as described later, is given.

When pairs to be compared in the (n-i)th tier do not have the order relationship, the determination unit 14 compares pairs in the (n-i+1)th tier that respectively correspond to the pairs in the (n-i)th tier. When the compared pairs in the (n-i+1)th tier satisfy the following two conditions, the determination unit 14 maintains the order relationship between the pairs to be compared in the (n-i)th tier. A condition 1 is that one of request information and response information of the third pair be transmitted or received before one of request information and response information of the fourth pair is transmitted or received. A condition 2 is that one of request information and response information of the fifth pair be transmitted or received after one of request information and response information of the fourth pair is transmitted or received. As an example of this process, the process of S27, which is performed by the constraint extraction unit 23 as described later, is given.

The configuration above enables the order relationship in the (n-i)th tier to be extracted on the basis of the order relationship between pairs of a request and a response in the (n-i+1)th tier that respectively correspond to pairs of a request and a response in the (n-i)th tier.

The transmission order determination device 1 further includes an output unit 15. The output unit 15 outputs information relating to a timing of transmitting request information to the information processing system, on the basis of the determined transmission order. As an example of the output unit 15, a reproduction time determination unit 24 is given.

The configuration above enables a change in a request transmission timing (shortening of intervals or order changing) to be performed.

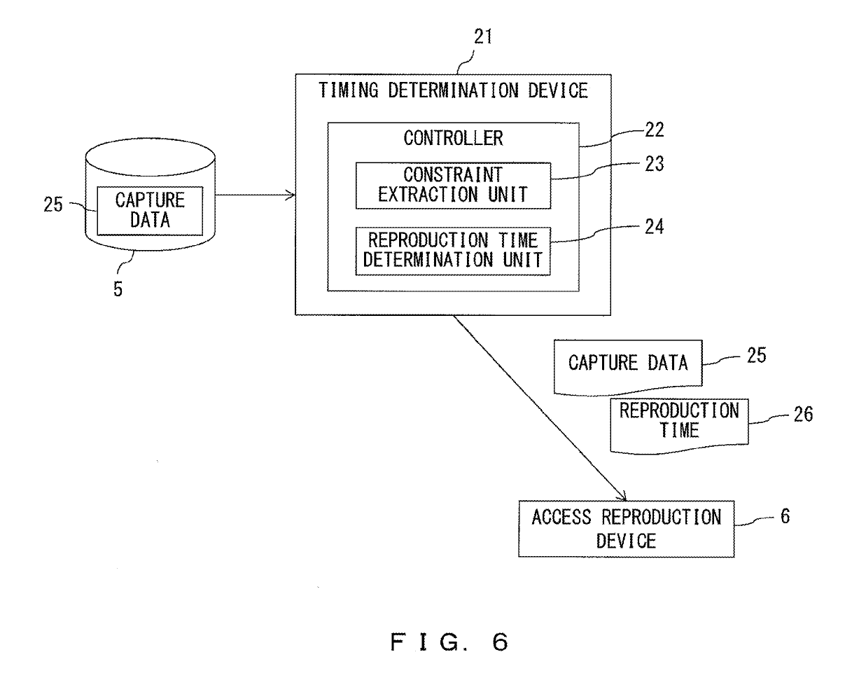

FIG. 6 illustrates an example of a timing determination device according to the embodiment. A storage device 5, a timing determination device 21, and an access reproduction device 6 are illustrated in FIG. 6. In the storage device 5, data of packets captured as described with reference to FIG. 1 (capture data 25) has been stored. The access reproduction device 6 is the same as the access reproduction device described with reference to FIG. 1, and the description thereof is omitted.

The timing determination device 21 obtains the capture data 25, determines a time of transmitting a communication packet included in the capture data 25 (a reproduction time), and generates reproduction time information 26.

The timing determination device 21 outputs the capture data 25 and the reproduction time information 26 to the access reproduction device 6. In the embodiment, the timing determination device 21 is provided separately from the access reproduction device 6, but the timing determination device 21 may be included in the access reproduction device 6. In FIG. 6, the capture data 25 and the reproduction time information 26 are separately output, but data obtained by updating a time in the capture data 25 to a reproduction time may be output.

The timing determination device 21 includes a controller 22. The controller 22 functions as the constraint extraction unit 23 and the reproduction time determination unit 24 by reading and executing a program according to the embodiment that has been stored in a storage device (not illustrated) in the timing determination device 21.

The constraint extraction unit 23 reads the capture data 25 from the storage device 5. The constraint extraction unit 23 obtains constraint information of a message transmission order in respective tiers in order from a side of a processing server that performs processing in reply to a request from a client in a system in which a plurality of servers perform communication according to a prescribed communication protocol. The reproduction time determination unit 24 determines a reproduction time on the basis of the obtained constraint information of the message transmission order in the respective tiers. The servers are not limited to server devices, and may be server programs.

In the embodiment, access reproduction can be performed on not only a two-tier system constructed of an HTTP server, a DB server, and the like but also on a multi-tier system constructed of three or more tiers.

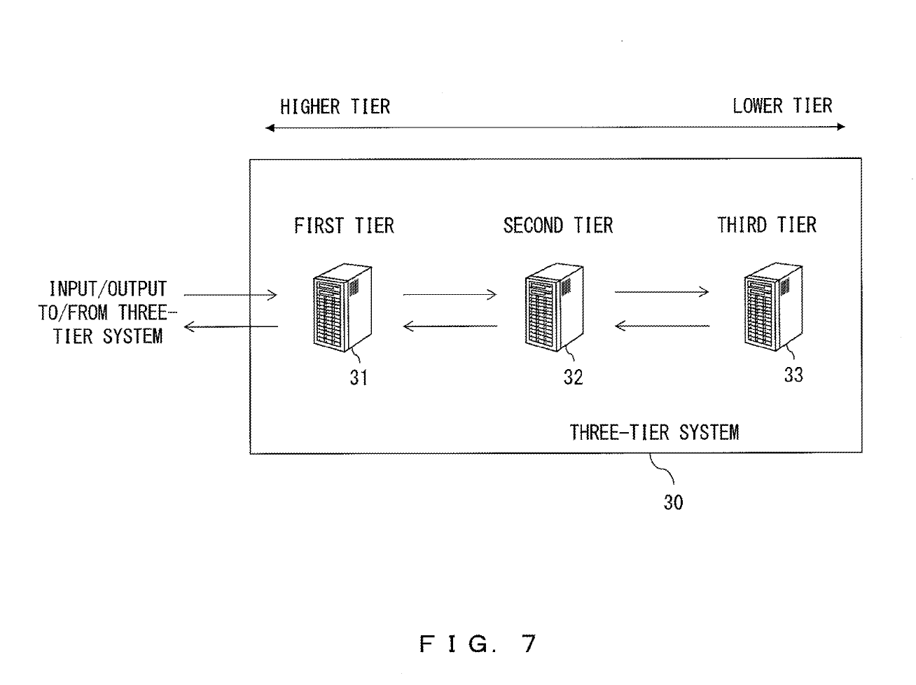

FIG. 7 illustrates an example of a multi-tier system on which access reproduction is performed according to the embodiment. A three-tier system 30 is illustrated in FIG. 7. The three-tier system 30 is constructed of a server 31 that forms a first tier as a presentation tier, a server 32 that forms a second tier as an application tier, and a server 32 that forms a third tier as a database tier.

Here, when a plurality of tiers are considered, a tier on an input (presentation tier) side is referred to as a “higher tier”. In FIG. 7, a tier having a small number is referred to as a “higher tier” than a tier having a large number. As an example, in a system including the HTTP server and the DB server, the HTTP server is referred to as a higher tier.

When a plurality of tiers are considered, a tier (database tier) that is far from the input is referred to as a “lower tier”. In FIG. 7, a tier having a large number is referred to as a “lower tier” than a tier having a small number. As an example, in the system including the HTTP server and the DB server, the DB server is referred to as a lower tier.

In a case of an n-tier system, the constraint extraction unit 23 extracts a transmission order constraint of a message in the (n-1)th tier from a constraint on a timing of transmitting a message between the (n-1)th tier and the n-th tier, in order from an end (a side of the n-th tier). Then, the constraint extraction unit 23 extracts the transmission order constraint of a message in the (n-2) th tier from a constraint on a timing of transmitting a message between the (n-2)th tier and the (n-1)th tier.

As an example, in a case of a three-tier system, the constraint extraction unit 23 extracts the transmission order constraint in the second tier from a constraint on a timing of transmitting a message between the second tier and the third tier. Then, the constraint extraction unit 23 extracts the transmission order constraint on a message in the first tier (a tier of input) from a constraint on a timing of transmitting a message between the first tier and the second tier.

As described above, the constraint extraction unit 23 extracts the transmission order constraint of a message in the (n-i)th tier from a constraint on a timing of transmitting a message between the (n-i)th tier and the (n-i+1)th tier (i=1, 2, . . . , n-1).

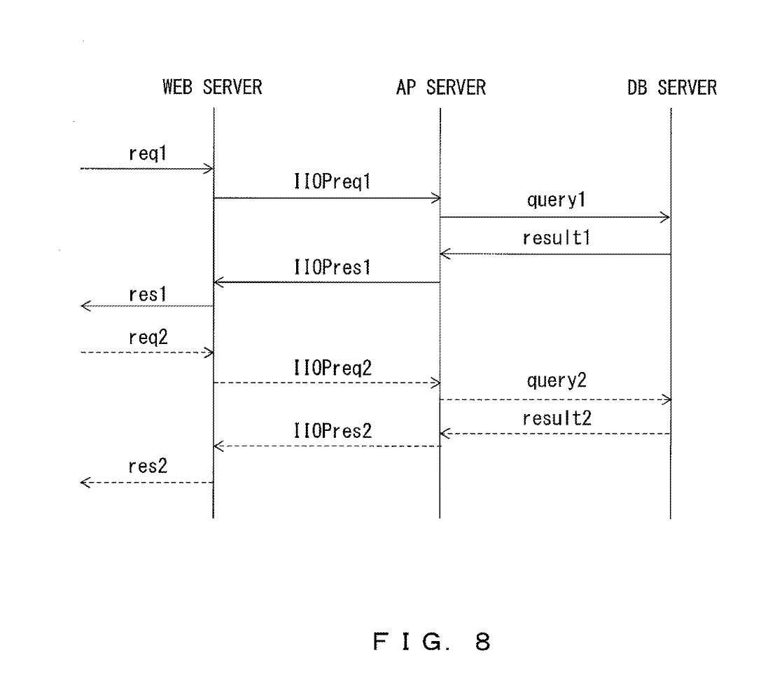

Here, the constraint on a timing of transmitting a message refers to, for example, a constraint whereby a message B is not transmitted until a response to a message A is received, or to other constraints because an execution result of a server based on the message A influences an execution result of a server based on the message B. This is described with reference to FIG. 8.

FIG. 8 is a diagram explaining an example of a constraint on a timing of transmitting a message between tiers according to the embodiment. A request message according to the IIOP that is transmitted from the WEB server to the AP server is referred to as an “IIOPreq”. A response message according to the IIOP that is transmitted from the AP server 3 to the WEB server is referred to as an “IIOPres”. An IIOPreq1 and an IIOPres1 are included in a transaction 1. An IIOPreq2 and an IIOPres2 are included in a transaction 2.

As an example, when the earlier execution of the query2 influences a result of the query1, it is requested that the query1 and the query 2 be executed in this order. In order that the query2 not be transmitted to the DB server earlier than the query1, the constraint extraction unit 23 extracts a constraint whereby the req2 is not transmitted until the res1 is received as the constraint on a timing of transmitting a message.

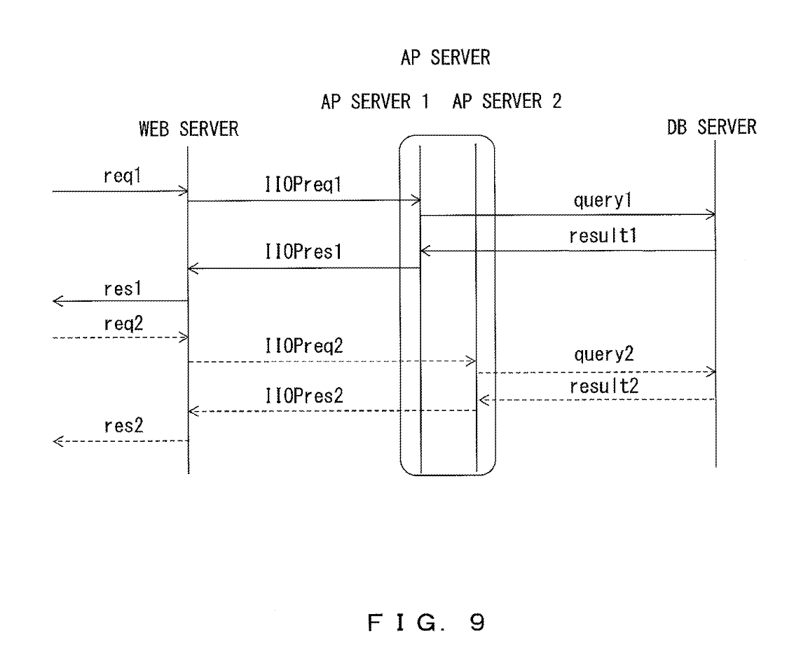

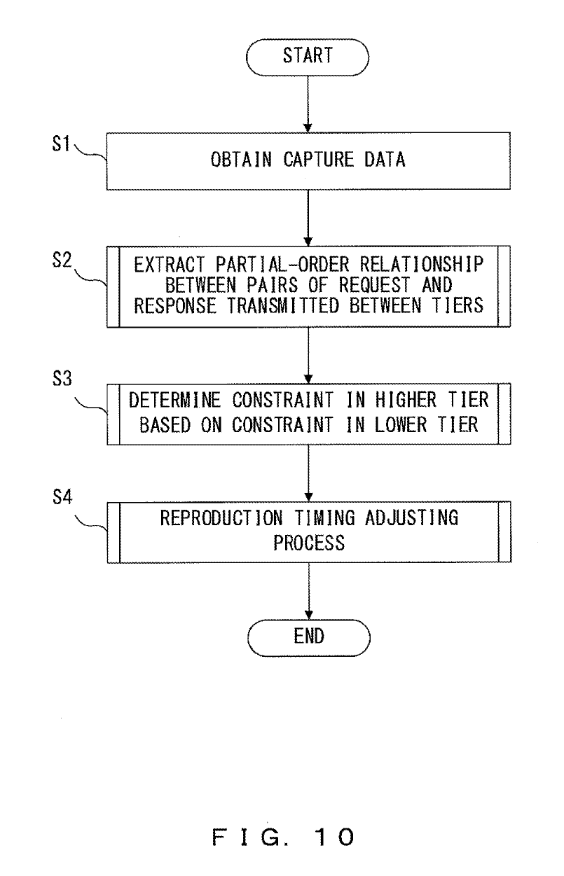

FIG. 9 is a diagram explaining an example of a constraint on a timing of transmitting a message between tiers in a case in which there are a plurality of servers in the same tier, according to the embodiment. It is assumed that an AP server 1 is used as the AP server in the transaction 1. It is also assumed that an AP server 2 is used as the AP server in the transaction 2.

When there are two AP servers and a query to the DB server has an order constraint, as illustrated in FIG. 9, a constraint on a timing of transmitting the IIOPreq or the IIOPres (a transmission order constraint) is generated. As an example, it is assumed that the query1 and the query2 have an order constraint. In this case, a transmission order relationship is requested for the IIOPreq1 or the IIOPres. The IIOPreq2 is prohibited from passing the IIOPres1, and a higher req2 is prohibited from passing a res2.

Accordingly, even when there are a plurality of servers in the same tier, it is a message transmission order that is focused on, and which AP server a message reaches does not matter. Therefore, a case in which there are a plurality of servers in the same tier is handled similarly to a case in which there is one server in one tier.

The extraction of a constraint on an order of a transmitted message is described next. A “partial order” is used to extract the constraint on an order of a transmitted message. The partial order is an order that satisfies the following relationships:

Reflexive property (a≦a)

Transitive property (a≦b̂b ≦c [symbol] a≦c)

Anti-symmetric property (a≦b̂b≦a [symbol] a=b)

Meanwhile, a relationship that satisfies a partial-order relationship with respect to a combination of arbitrary elements is referred to as a “total order relationship”. As an example that has a partial order but does not have a total order, the following inclusion relationship of a family of subsets is given.

As an example, when considering a subset of {1, 2, 3}, {φ, {1}, {2}, {3}, {1, 2}, {1, 3}, {2, 3}, {1, 2, 3}}, the inclusion relationship is a partial order. Accordingly, {1, 2} and {2, 3} have no inclusion relationship, and are not put in order. Events such as a response or a request, e.g., a pair of HTTP requests that has no dependency, such as a transfer of data using cookies, have no order relationship, and therefore the partial order is used in the embodiment.

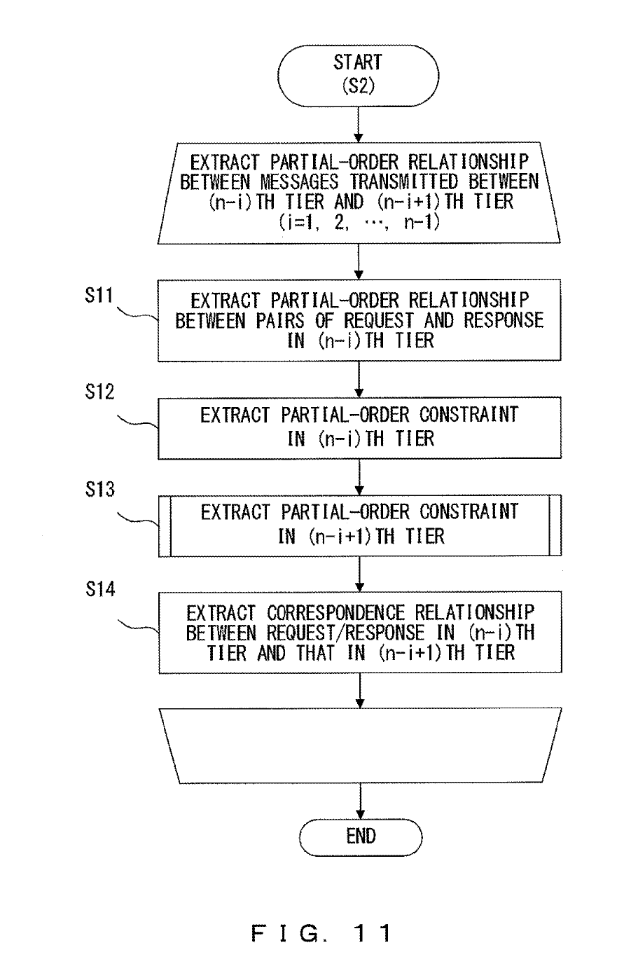

FIG. 10 illustrates the entire processing flow according to the embodiment. First, the controller 22 in the timing determination device 21 functions as the constraint extraction unit 23, and obtains the capture data 25 from the storage device 5 (S1). The controller 22 obtains the capture data by using a port mirror ring function of switch devices provided between the HTTP server, the AP server, and the DB server. The mirror ring function is a function for outputting the same data as data output to a port, from another port.

Log data relating to communication that has been stored in a server in each of the tiers may be used instead of the capture data 25. As an example, the constraint extraction unit 23 may obtain a history of an HTTP or IIOP request message and an HTTP response message that are output in a communication log stored in the server in each of the tiers, and history information of a query to the DB and a result thereof.

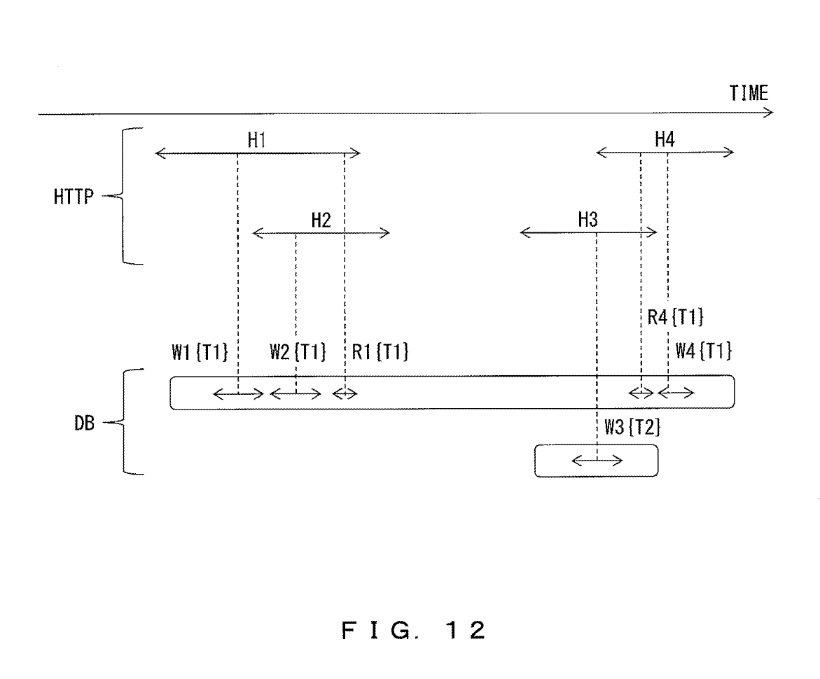

Then, the constraint extraction unit 23 generates pairs of a request and a response transmitted between tiers from the capture data 25, and extracts a partial-order relationship between the pairs (S2). Details of S2 are described with reference to FIG. 11.

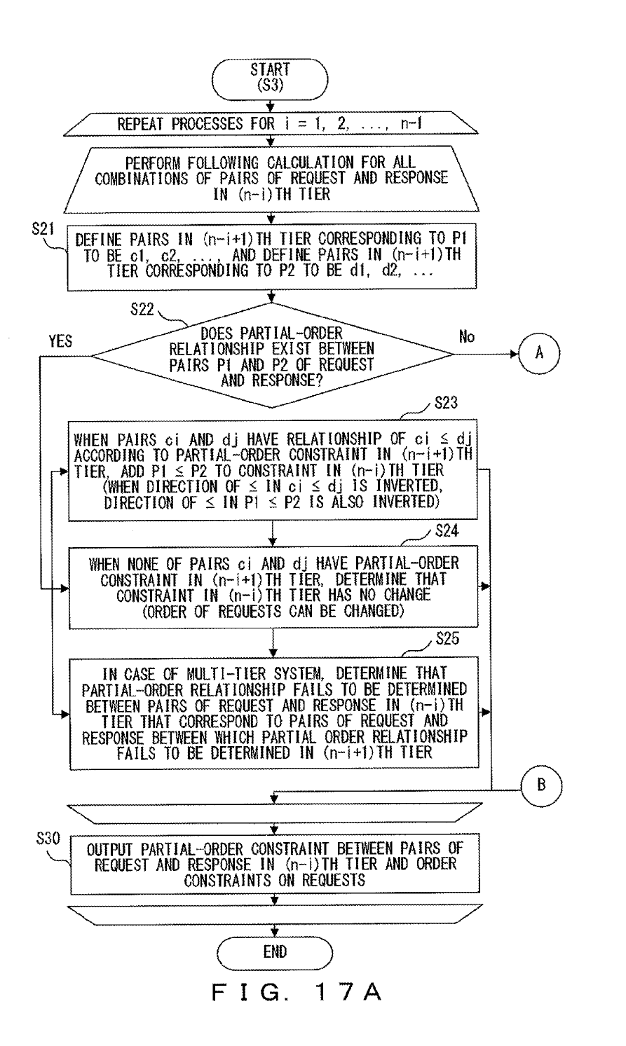

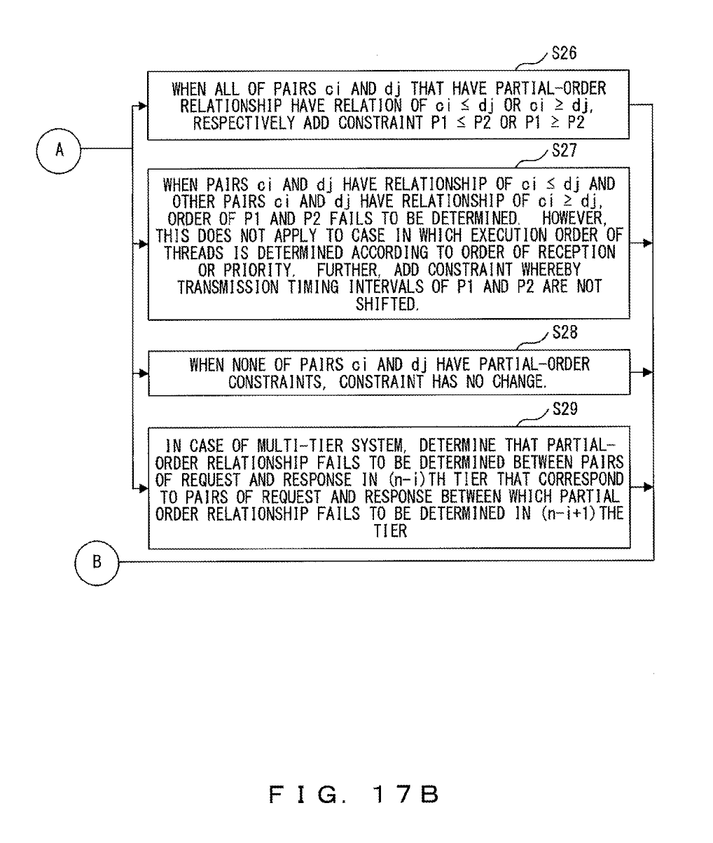

Then, the constraint extraction unit 23 performs a process of determining a constraint in a higher tier based on a constraint in a lower tier on the basis of the partial-order relationship between the pairs of a request and a response that has been extracted in S2 (S3). Details of S3 are described with reference to FIGS. 17A and 17B.

The constraint extraction unit 23 adjusts a reproduction timing on the basis of the constraint information determined in S3 (S4). Details of S4 are described with reference to FIG. 18.

FIG. 11 illustrates details of a flow (S2) of extracting a partial-order relationship between pairs of a request and a response transmitted between tiers according to the embodiment. The processes of S11 to 14 are loop processing that is repeated while performing increments within a range of i=1, 2, . . . , n-1. An initial value of i is “1”. n is the number of tiers.

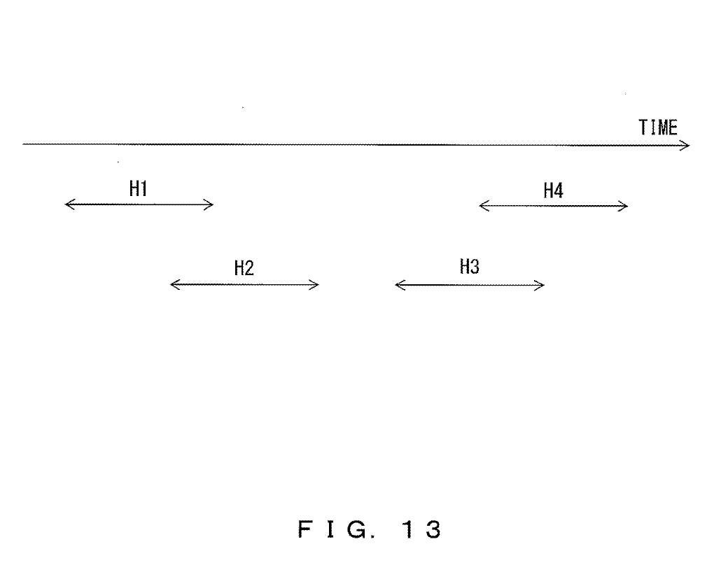

The constraint extraction unit 23 extracts a partial-order relationship between pairs of a request transmitted to the (n-i)th tier (higher-side tier) and a response to the request (S11). This is described with reference to FIG. 12 and FIG. 13.

FIG. 12 illustrates the content of capture data used in the embodiment. FIG. 12 illustrates an example of receiving/transmitting a message between an HTTP tier as the (n-i)th tier and a DB tier as the (n-i+1)th tier. The capture data 25 obtained in S1 is assumed to be packet data corresponding to a message received/transmitted between the HTTP tier and the DB tier at a timing as illustrated in FIG. 12, for example.

In FIG. 12, an update query to the DB is expressed as W, and a non-update query to the DB is expressed as R. A query for updating a region T in the DB is expressed as W{T}, and a query for referring to the region T is expressed as R{T}. The region T is, for example, one or more tables that are managed in the DB. FIG. 13 is a drawing focusing on the HTTP tier in FIG. 12.

FIG. 13 is a diagram explaining a process (S11) of extracting a partial-order relationship between pairs of a request transmitted to the (n-i+1)th tier and a response received from the (n-i+1)th tier in the (n-i)th tier according to the embodiment.

First, in the (n-i)th tier, the partial-order relationship between the pairs of the request transmitted to the (n-i+1)th tier and the response received from the (n-i+1)th tier is defined as described below.

(Definition 1) Pairs <request1, response1>, <request2, response2>, . . . , <request n, response n>, and the like are expressed as H1, H2, . . . , Hn, and the like. In addition, <request X, response X>≦<request Y, response Y>, namely, HX≦HY, is defined to be “time of response X≦time of request Y”. In the example of FIG. 12, a partial-order relationship of H1≦H3, H1≦H4, H2≦H3, H2≦H4 is established. In this case, no order relationships are established between H1 and H2 or between H3 and H4.

(Definition 2) The order of requests is defined on the basis of the order of the time. Namely, the transmission of the request2 after the request1 is defined to be “request1≦request2”.

The constraint extraction unit 23 extracts pairs of a request and a response to the request in the (n-i)th tier from the capture data 25 on the basis of information set in a packet header included in the capture data 25. The constraint extraction unit 23 determines the order of the pairs of a request and a response according to the definition 1, and generates a partial-order relationship. Return now to the description of FIG. 11.

The constraint extraction unit 23 extracts a partial-order constraint in the (n-i)th tier (higher-side tier) from the capture data 25 (S12). The partial-order constraint in the (n-i)th tier (higher-side tier) is a constraint whereby an HTTP response transfers data to a HTTP request that follows by using, for example, cookies or other constraints.

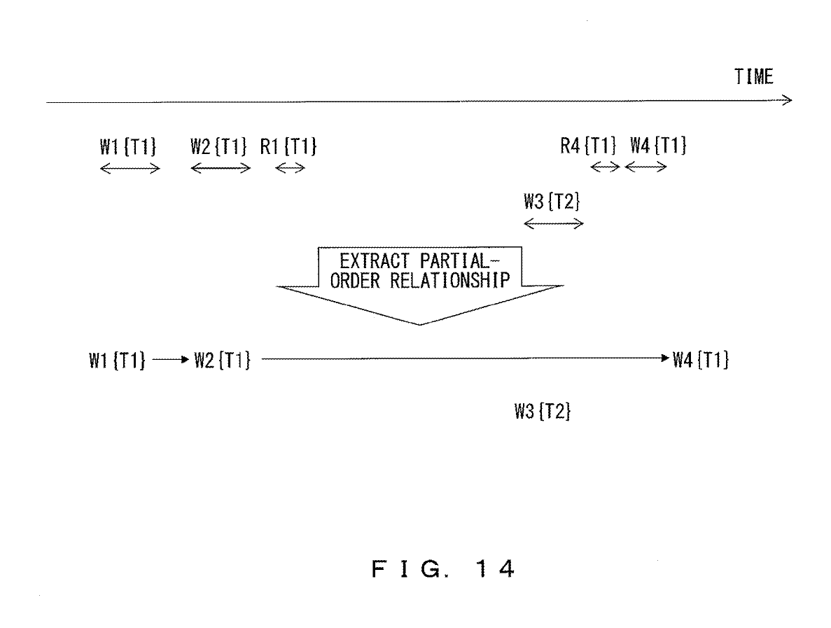

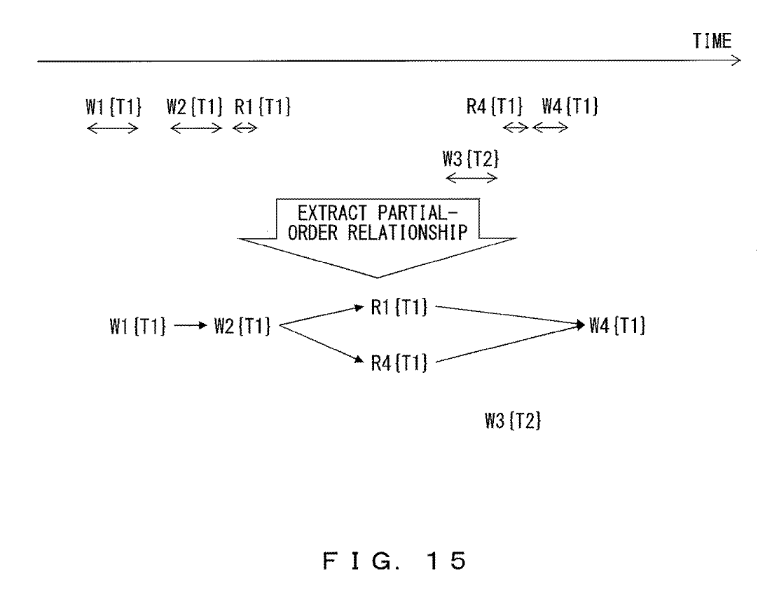

The constraint extraction unit 23 then extracts a partial-order constraint in the (n-i+1)th tier (lower-side tier) from the capture data 25 (S13). The partial-order constraint in the (n-i+1)th tier (lower-side tier) is an order constraint on a query to, for example, the DB and the result, and this is described with reference to FIG. 14 and FIG. 15.

FIG. 14 is a diagram explaining the extraction of a partial-order relationship between queries for updating a region (table) in a DB according to the embodiment. FIG. 14 corresponds to the DB tier in FIG. 12. The constraint extraction unit 23 extracts queries for updating the same region (table) from the capture data 25, and extracts a partial-order relationship between the update queries according to the definition 1 above. As a result, a model on a lower side of FIG. 14 is obtained.

FIG. 15 is a diagram explaining the extraction of an order relationship between a reference query and an update query in the DB according to the embodiment. In FIG. 15, queries that access the same region (table) in the DB are classified into update queries and non-update queries, and it is assumed that the non-update queries between the update queries are not put in order. Because a result of queries is not changed even when the order of the non-update queries is changed, a partial-order relationship is set so as to not determine the order of the non-update queries.

In the case of FIG. 15, the constraint extraction unit 23 does not order non-update queries R1{T1} and R4{T1} between update queries from among queries that access the same region (table).

When retransmission is performed due to a packet loss in a communication network, or when no partial-order relationship is established between pairs of a request and a response, the order of requests to the DB may be changed. In view of this, a technology for reproducing the order of accesses to the DB is used in the embodiment. As an example, a transmission order of requests may be stored in advance when observing packet communication, and the constraint extraction unit 23 may maintain an issuing order of the requests, i.e., queries, by using information relating to the stored transmission order.

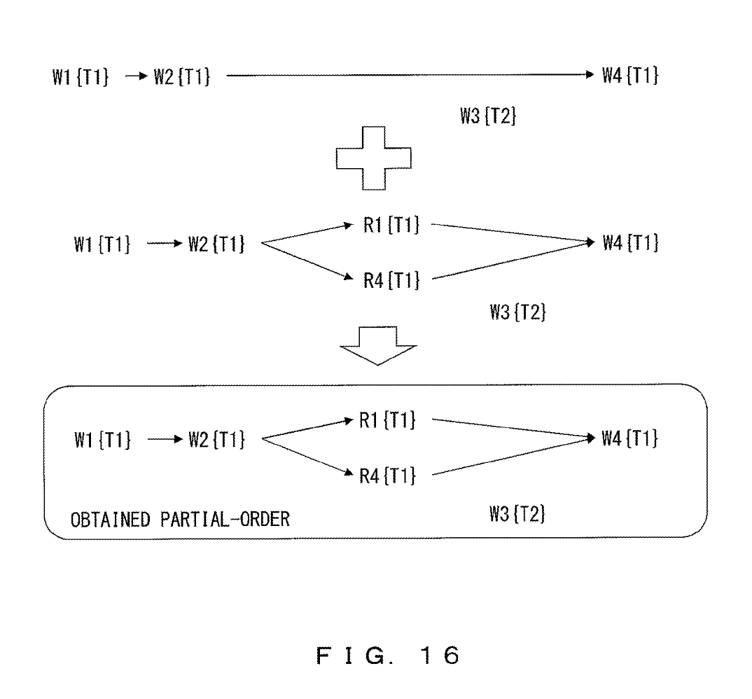

FIG. 16 is a diagram explaining the composition of a plurality of partial-order relationships according to the embodiment. Here, partial-order relationships to be satisfied are given independently, and a partial-order relationship that satisfies the given partial-order relationships is generated. This results in independently describing characteristics of a plurality of partial-order relationships because the partial-order relationships to be satisfied are given independently. Accordingly, an algorithm does not need to be considered for each of the combinations of characteristics. The partial orders obtained in FIG. 14 and FIG. 15 are independent of each other.

A method for composing partial-order relationships is as described below. When partial-order relationships R and R′ are given, the composition R+R′ is defined as a transitive closure of R ∪ R′. The transitive closure refers to a set obtained by performing addition if one partial-order relationship has a relationship that another partial-order relationship does not satisfy and adding a relationship according to the transitive property (a≦b̂b≦c [symbol] a≦c). As an example, when R={a≦b} and R′={b ≦c}, the composition R+R′={a≦b, b≦c, a≦c} is obtained.

In FIG. 16, when the partial-order relationship obtained in FIG. 14 and the partial-order relationship obtained in FIG. 15 are composed, a partial-order relationship surrounded with a solid line is obtained. Return now to the description of FIG. 11.

The constraint extraction unit 23 extracts a correspondence relationship between a request/response in the (n-i)th tier (higher-side tier) and that in the (n-i+1) th tier (lower-side tier) from the capture data 25 (S14). In other words, the constraint extraction unit 23 detects from the capture data 25 which request in the (n-i)th tier has caused a request in the (n-i+1)th tier to be issued.

In the process of S14, the constraint extraction unit 23 uses a system visualization technology for visualizing a behavior inside a system and for determining which request in a higher tier has caused which request in an lower tier to be issued. One of the system visualization technologies is a technology for supporting a linkage process for linking messages associated with each other from among a plurality of messages transmitted/received between a plurality of communication terminals (for example, Patent Document 4). In this system visualization technology, a computer receives a message type of a message transmitted/received as input between servers, an ID character string included in the message, and a data flow rate of the message. The computer outputs information indicating an execution order of linkage processes using respective ID character strings, and ID character strings that enable the performing of the linkage processes in parallel in the form of a partial-order graph on the basis of the received information. As a result, messages associated between tiers can be linked in the same transaction.

In FIG. 12, for example, a message in the HTTP tier and a query in the DB tier in the same transaction are linked with a broken line by using the system visualization technology.

FIGS. 17A and 17B illustrate details of a flow of determining a constraint in a higher tier on the basis of a constraint in a lower tier according to the embodiment. The constraint extraction unit 23 repeats the processes of S21-S28 for all of the combinations of pairs of a request and a response in the (n-i)th tier (higher-side tier). Further, the processes of S21-S29 are repeated while performing incrementing within a range of i=1, 2, . . . , n-1. Constraint information in the (n-i)th tier (higher-side tier) is stored in a storage device (not illustrated) in the timing determination device 21.

The constraint extraction unit 23 defines a pair of a request and a response in the transaction 1 in the (n-i)th tier (higher-sider tier) as P1, and defines a pair of a request and a response in the transaction 2 as P2. The constraint extraction unit 23 further defines pairs in the (n-i+1) th tier (lower-side tier) corresponding to P1 as c1, c2, . . . , and defines pairs in the (n-i+1)th tier (lower-side tier) corresponding to P2 as d1, d2, . . . (S21).

When the pairs P1 and P2 of a request and a response have a partial-order relationship (when P1 and P2 are not processed simultaneously) (“Yes” in S22), the constraint extraction unit 23 performs the following process. Namely, when pairs ci and dj (i, j=1, 2, . . . ) have a relationship of ci≦dj according to a partial-order constraint in the (n-i+1)th tier, the constraint extraction unit 23 adds P1≦P2 to a constraint in the (n-i)th tier (S23). When a direction of ≦ in ci≦dj is inverted, a direction of ≦ in P1≦P2 is also inverted. In other words, when the pairs have a relationship of ci≧dj according to the partial-order constraint in the (n-i+1)th tier, the constraint extraction unit 23 adds P1≧P2 to the constraint in the (n-i)th tier.

When none of the pairs of ci and dj have the partial-order constraint in the (n-i+1)th tier, the constraint in the (n-i)th tier has no change. In this case, the constraint extraction unit 23 determines that the order of requests can be changed (S24).

In a case of a multi-tier system, the constraint extraction unit 23 determines that a partial-order relationship fails to be determined between pairs of a request and a response in the (n-i)th tier that corresponds to pairs of a request and a response between which a partial-order relationship fails to be determined in the (n-i+1)th tier (S25).

When the pairs P1 and P2 of a request and a response do not have a partial-order relationship (when P1 and P2 are processed simultaneously) (“No” in S22), the constraint extraction unit 23 performs the following process. Namely, when all of the arbitrary pairs ci and dj that have a partial-order relationship have a relationship of ci≦dj or ci≧dj, the constraint extraction unit 23 respectively adds a constraint of P1≦P2 or P1≧P2 (S26).

When pairs ci and dj have a relationship of ci≦dj and other pairs ci and dj have a relationship of ci≧dj, the constraint extraction unit 23 determines that an order fails to be determined because results of P1 and P2 may be changed. However, the same does not apply when an execution order of threads is determined in the order of reception or priority. The constraint extraction unit 23 also adds a constraint whereby transmission timing intervals of P1 and P2 are not shifted (S27).

When none of the pairs ci and dj have the partial-order constraint, the constraint extraction unit 23 determines that the constraint has no change (S28).

In a case of a multi-tier system, the constraint extraction unit 23 determines that a partial-order relationship also fails to be determined between pairs of a request and a response in the (n-i)th tier that correspond to pairs of a request and a response between which a partial-order relationship in the (n-i+1)th tier fails to be determined (S29).

When the processes of S21-S29 are finished for all of the combinations of the pairs of a request and a response in the (n-i)th tier, the constraint extraction unit 23 outputs a partial-order constraint between the pairs of a request and a response and an order constraint on requests in the (n-i)th tier (S30).

The processes of S21-S29 are described with reference to FIG. 12 and FIG. 16. Here, a constraint in the HTTP tier is extracted by comparing respective pairs H1, H2, H3, and H4 of a request and a response in the HTTP tier. As described above, the partial-order relationship is H1≦H3, H1≦H4, H2≦H3, H2≦H4.

A pair in a lower tier that corresponds to H1 is (W1{T1}, R1{T1}). A pair in a lower tier that corresponds to H2 is (W2{T1}). A pair in a lower tier that corresponds to H3 is (W3{T2}). A pair in a lower tier that corresponds to H4 is (R2{T1}, W4{T1}).

Comparing H1 and H2, H1 and H2 do not have the partial-order relationship (“No” in S22), and W1{T1}≦W2{T1}≦R1{T1} is satisfied, and therefore the constraint extraction unit 23 determines that the order of H1 and H2 fails to be determined because an execution result may be changed. In this case, a constraint whereby an access order of H1 and H2 is not changed with no change in transmission timing intervals (access reproduction constraint: request of H1≦request of H2) is established (S27).

Comparing H1 and H3, H1 and H3 have the partial-order relationship (“Yes” in S22), but (W1{T1}, R1{T1}) and (W3{T2}) do not have the partial-order relationship, and therefore the constraint extraction unit 23 determines that no constraints are added to the constraint in the HTTP tier (S24). Comparing H2 and H3, H2 and H3 have the partial-order relationship (“Yes” in S22), but W2{T1} and W3{T2} do not have the partial-order relationship, and therefore the constraint extraction unit 23 determines that no constraints are added to the constraint in the HTTP tier (S24).

Comparing H1 and H4, the partial-order relationship between pairs of a request and a response is H1≦H4 (“Yes” in S22), and a constraint of R1{T1}≦W4{T1} is established, and therefore the constraint extraction unit 23 adds a constraint of H1≦H4 to the constraint in the HTTP tier (S23).

Comparing H2 and H4, the partial-order relationship between pairs of a request and a response is H2≦H4 (“Yes” in S22), and a constraint of W2{T1}≦W4{T1} is established. Therefore, the constraint extraction unit 23 adds a constraint of H2≦H4 to the constraint in the HTTP tier (S23).

Comparing H3 and H4, H3 and H4 do not have the partial-order relationship (“No” in S22), and (W3{T2}) and (R2{T1}, W4{T1}) do not have the partial-order relationship. Therefore, the constraint extraction unit 23 determines that no constraints are added to the constraint in the HTTP tier (S28).

The constraint in the HTTP tier obtained as a result of the foregoing is as follows.
An order constraint in the HTTP tier is {H1≦H4, H2≦H4}. Because H3 has no constraints, H3 can be transmitted without awaiting the responses of H1 and H2. H4 can be transmitted after awaiting the responses of H1 and H2.
Likelihood of a change in an execution result as a result of comparison between execution results: Because an execution result may be changed, the order of H1 and H2 fails to be determined (a developer makes determination according to an internal implementation method).
An access reproduction constraint of request of H1 request of H2 is established.

Details of a process (S4) of adjusting a reproduction timing on the basis of the constraint information determined in S3 are described next.

FIG. 18 illustrates an example of shortening an access reproduction time on the basis of a constraint according to the embodiment. Because a request of H3 can be freely set on the basis of the order constraint {H1≦H4, H2≦H4} and the access reproduction constraint {request of H1≦request of H2}, the reproduction time determination unit 24 determines that the request of H3 is transmitted after the request of H1 is transmitted. The reproduction time determination unit 24 also determines that a request of H4 is transmitted after responses of H1 and H2 are received.

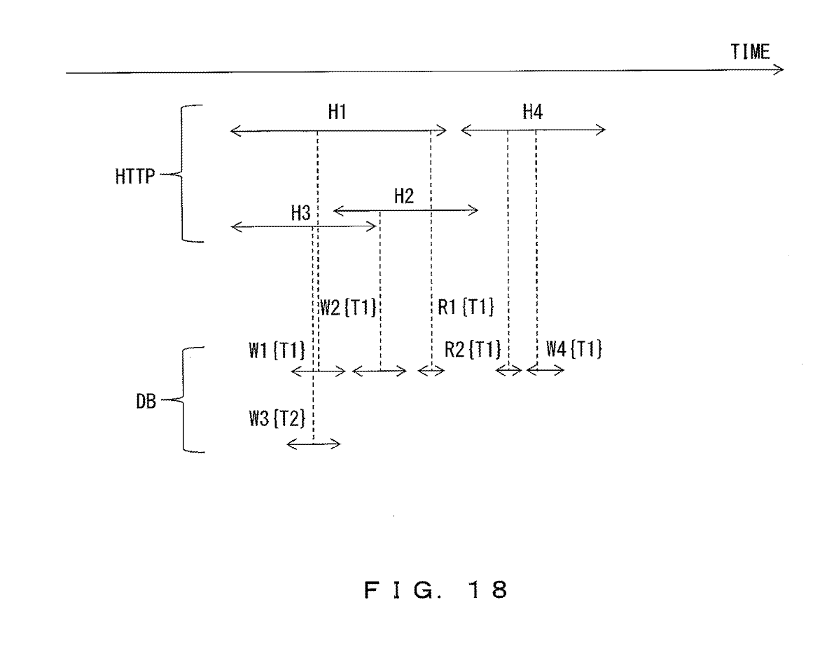

As illustrated in FIG. 19, a request issuing order in a higher tier may be changed in order to satisfy a constraint in a lower tier.

FIG. 19 is a diagram explaining a case in which a request issuing order in a higher tier is changed in order to satisfy a constraint in a lower tier according to the embodiment. An observation timing is assumed to be a timing as illustrated in FIG. 19(A).

As described with reference to FIG. 14 and FIG. 15, an order constraint in the DB tier as illustrated in FIG. 19 (B) is obtained from FIG. 19(A). In order to satisfy the constraint in the DB tier illustrated in FIG. 19(B), an order constraint in the HTTP tier is H2≦H1, as illustrated in FIG. 19(C). In this case, the reproduction time determination unit 24 adjusts a reproduction timing such that a request of H1 is transmitted after a response of H2 is received.

According to the embodiment, requests can be transmitted taking into consideration an order in a plurality of tiers by obtaining pairs of a request and a response that have a partial-order relationship for respective tiers and by determining an order of transmitting requests to a multi-tier system on the basis of an order relationship in a higher tier that is extracted according to a partial-order relationship in a lower tier.

Examples of the embodiment are described below.

### EXAMPLE 1

In Example 1, an example of the process described above (S13) for extracting an order constraint on requests is described. An order constraint on queries for updating the same table from among queries to the DB is assumed to be the issuing order of the queries. It is assumed that, from among the queries to the DB, non-update queries (namely, queries for only performing reference) are unordered unless an update query exists between the non-update queries.

In a system in which updating is performed, it is assumed that an order constraint on requests that update the same region to be accessed is an issuing order of the requests. It is assumed that an order constraint on non-update requests (namely, requests only for performing referring) is that the non-update requests are unordered unless an update request exists between the non-update queries.

Whether the content of a request is the updating of data is defined according to a syntax. As an example, the SQL defines that an “update” statement is executed so as to perform updating, that a “select” statement is executed so as to not perform updating, or the like.

A region to be accessed is also defined by a syntax. In the SQL, for example, the region to be accessed is defined by a variable of a position of Table, such as “select * from Table” in the “select” statement.

In generating a constraint in the (n-i)th tier based on a constraint in the (n-i+1) th tier (S13), when the (n-i+1) th tier is the DB tier and the (n-i)th tier is the HTTP tier, an order constraint in the HTTP tier is generated from an order constraint in the DB tier. The process of S13 for extracting a constraint in the DB tier is described below.

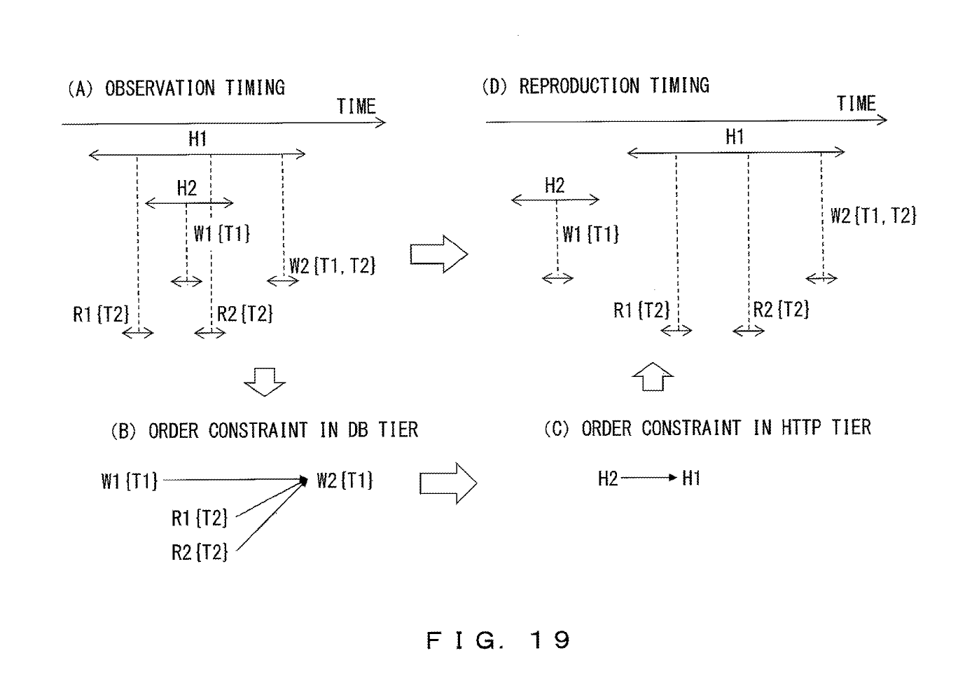

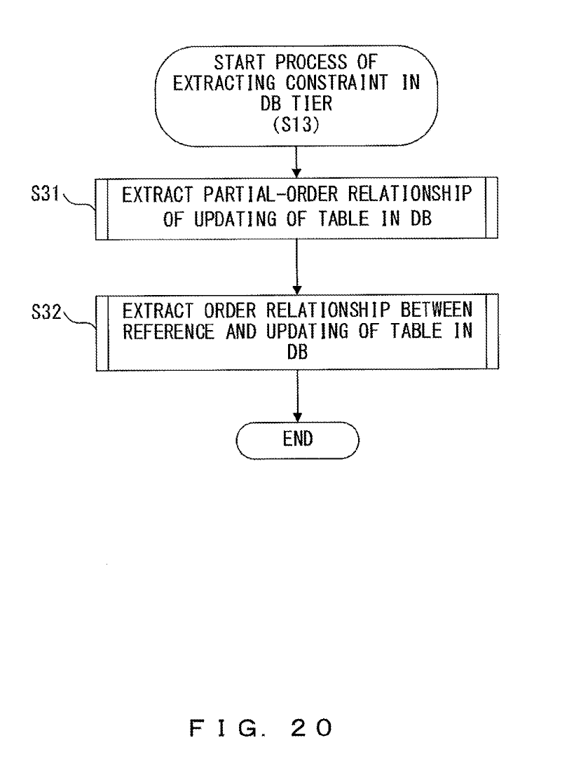

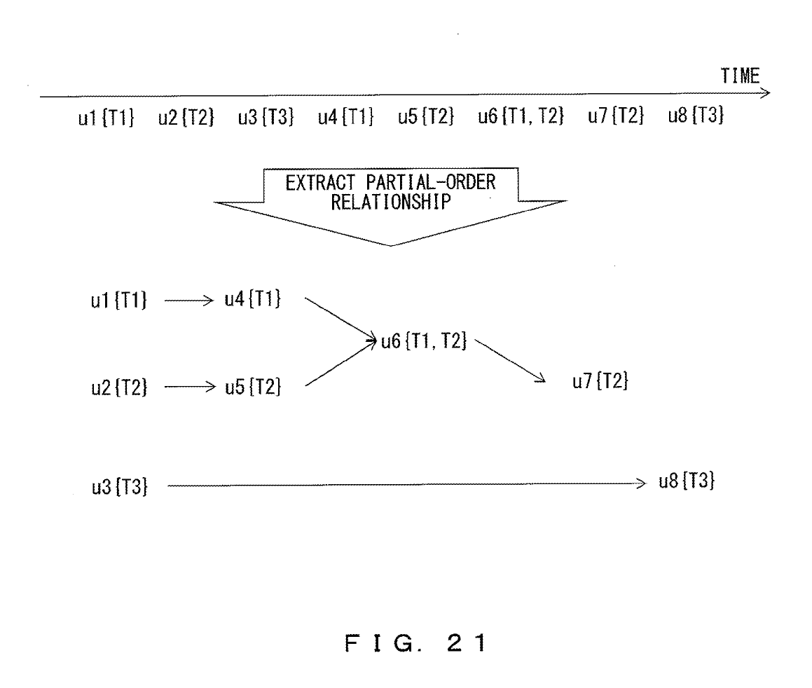

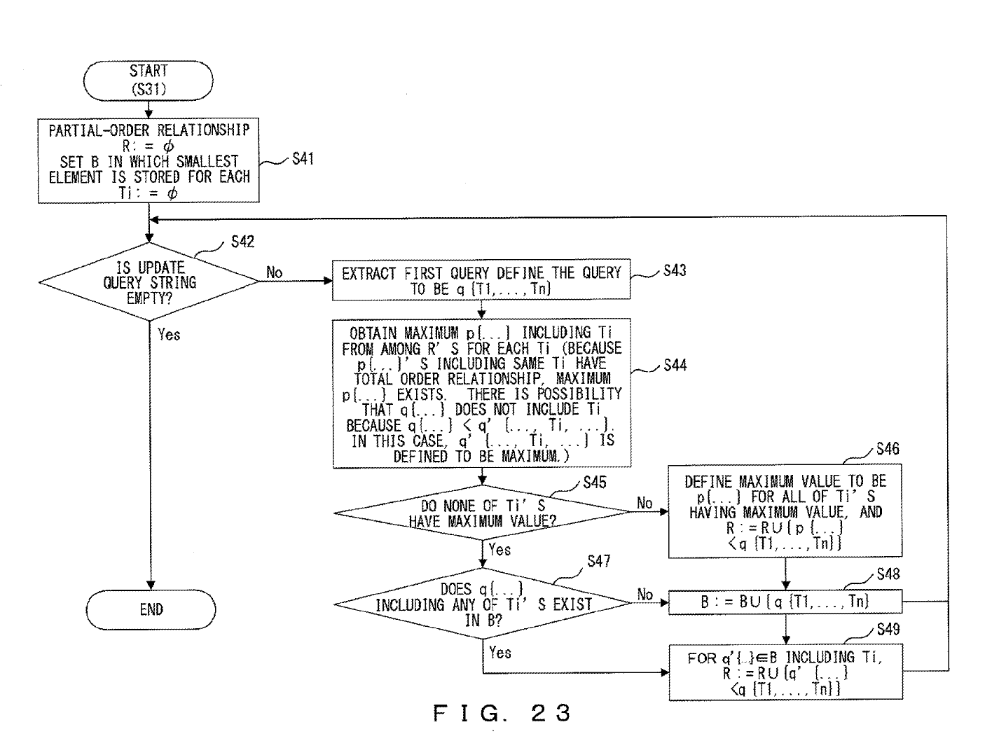

FIG. 20 illustrates a flow of a process of extracting a constraint in the DB tier, which is included in the process of S13 according to the embodiment (Example 1). The constraint extraction unit 23 extracts a partial-order relationship for updating a table in the DB (S31). The process of S31 is described with reference to FIG. 21 and FIG. 23.

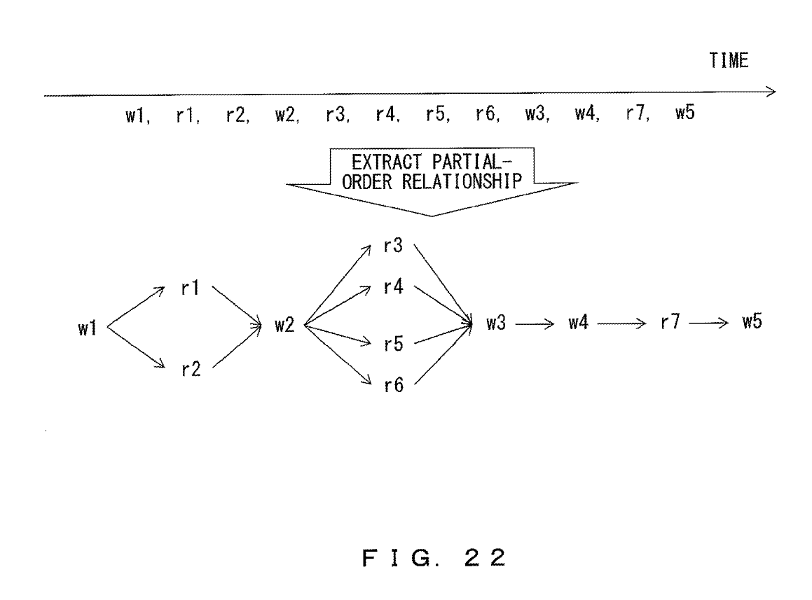

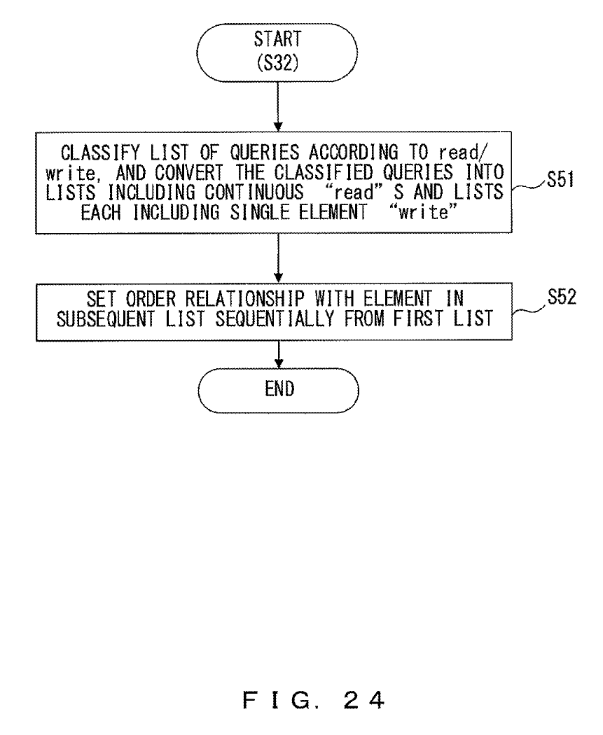

Then, the constraint extraction unit 23 extracts an order relationship between reference and updating of the table in the DB (S32). The process of S32 is described with reference to FIG. 22 and FIG. 24.

FIG. 21 is a diagram explaining the extraction of a partial-order relationship in a case of updating a table in the DB according to the embodiment (Example 1). As the order of update queries to the DB, a partial-order relationship is set between queries that access the same table.

Here, a query for updating tables T1 and T2 in the DB is expressed as u{T1, T2}. A time axis in FIG. 18 proceeds from a left side to a right side. Queries are assumed to be issued along the time axis. The queries are also assumed to be processed in the issuing order.

A partial-order relationship of queries u1{T1}, u2{T2}, u3{T3}, u4{T1}, u5{T2}, u6{T1, T2}, u7{T2}, and u8{T3} is extracted as illustrated in a lower portion of FIG. 21.

FIG. 22 is a diagram explaining an order relationship between a reference query and an update query to the DB according to the embodiment (Example 1). A time axis in FIG. 22 proceeds from a left side to a right side.

Queries that access the same table are classified into queries that include updating and queries that do not include updating. In addition, a plurality of non-update queries between update queries are not put in order. In other words, a result has no change even when the order of non-update queries is changed, and therefore a partial-order relationship is set such that an order is not determined for non-update queries.

In FIG. 22, it is assumed that “w” expresses a query that includes updating and that “r” expresses a query that does not include updating. As an example, it is assumed that queries w1, r1, r2, w2, r3, r4, r5, r6, w3, w4, r7, and w5 sequentially access the same table. It is also assumed that the queries are processed in this order. When a partial-order relationship in this case is extracted, a relationship illustrated in a lower portion of FIG. 22 is obtained.

FIG. 23 illustrates a flow (S31) of extracting a partial order relating to an update query according to the embodiment (Example 1). The flow of FIG. 23 is a flow that corresponds to the process of extracting a partial-order relationship, which has been described with reference to FIG. 21. W{T} and R{T} are collectively expressed as q{T}. Hereinafter, satisfying Ti∈{. . . } with respect to q{. . . } is expressed as “q{. . . } includes Ti”. Here, Ti is a table managed in the DB. In the flow of FIG. 23, it is assumed that a size of a query is based on the issuing order along the time axis.

The constraint extraction unit 23 initializes a partial-order relationship R and a set B in which the smallest element is stored for each Ti to an empty set (φ) (S41). The constraint extraction unit 23 determines whether an update query string is empty (S42). Here, the update query string is u1{T1}, u2{T2}, u3{T3}, u4{T1}u5{T2}, u6{T1, T2}, u7{T2{, u8{T3} in the case illustrated in FIG. 21.

When the update query string is not empty (“No” in S42), the constraint extraction unit 23 extracts the first query q{T1, . . . , Tn} from the update query string (S43).

The constraint extraction unit 23 obtains the largest query p{. . . } that includes Ti from among R's for respective Ti's (S44). Here, because p{. . . }'s that include the same Ti have a total order relationship, the largest query p{. . . } exists. There is a possibility that q{. . . } does not include Ti because q{. . . }<q′{. . . , Ti, . . . }. In this case, q′f . . . , Ti, . . . } is defined to be a maximum.

When one or more Ti's have a maximum value (“No” in S45), the constraint extraction unit 23 defines the maximum value to be p{. . . } for all of the Ti's having the maximum value, and stores the union of R and {p{. . . }<q{T1, . . . , Tn}} in R (S46).

When no Ti's have a maximum value (“Yes” in S45), the constraint extraction unit 23 determines whether q{. . . } that includes one of the Ti's exists in B (S47). When q{. . . } that includes one of the Ti's does not exist in B (“No” in S47), the constraint extraction unit 23 stores the union of B and q{T1, . . . , Tn}} in B (S48).

When q{. . . } that includes one of the Ti's exists in B (“Yes” in S47), the constraint extraction unit 23 stores the union of R and {q′{. . . }<q{T1, . . . , Tn}}} in R with respect to q′{. . . }∈B that includes Ti (S49).

The processes of S43-S49 are repeated until the update query string becomes an empty string. When the update query string becomes empty (“Yes” in S42), this flow is finished.

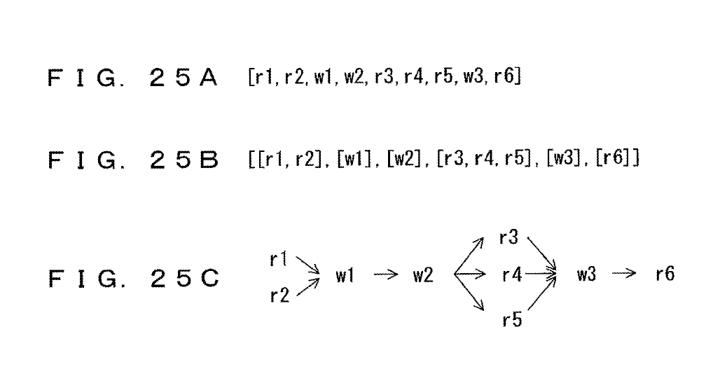

FIG. 24 illustrates a flow (S32) of extracting a partial-order relationship between a reference query and an update query to the same table according to the embodiment (Example 1). FIG. 25A to FIG. 25C illustrate an example of setting a partial-order relationship between a reference query and an update query to the same table according to the embodiment (Example 1). FIG. 24 is described below with reference to FIG. 25A to FIG. 25C.

The constraint extraction unit 23 classifies a list of queries that have been sequentially issued according to read/write, as illustrated in FIG. 25A. The constraint extraction unit 23 divides the classified queries into lists including continuous “read”s and lists each including a single element “write”, as illustrated in FIG. 25B (S51).

The constraint extraction unit 23 sets an order relationship with an element in a subsequent read/write list sequentially from the first read/write list, as illustrated in FIG. 25C (S52).

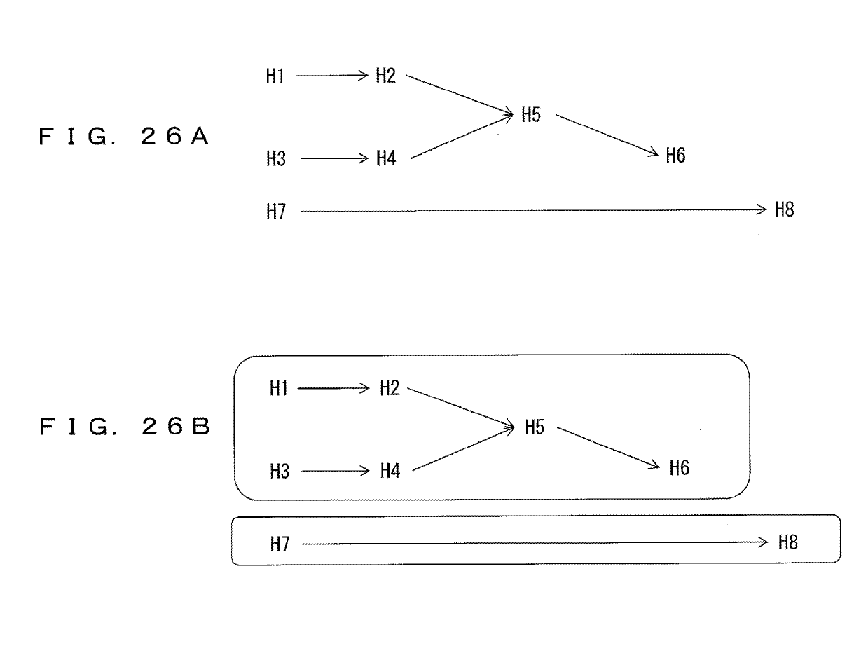

FIG. 26A and FIG. 26B are diagrams explaining the division of data based on an order relationship according to the embodiment (Example 1). The constraint extraction unit divides a partial-order constraint obtained by the extraction into groups of requests that can be tracked according to partial-order relationships.

Assuming, for example, that a partial-order constraint as illustrated in FIG. 26A is eventually obtained, the constraint extraction unit 23 divides the partial-order constraint into groups of requests having partial-order relationships, as illustrated in FIG. 26B. H7 and H8 do not have a partial-order relationship with any one of H1, . . . , H6, and can be independently executed.

### EXAMPLE 2

In Example 2, reproduction with a request issuing time changed is performed in order to satisfy a partial-order relationship obtained by extraction. This allows a test time to be shortened by advancing an issuing time.

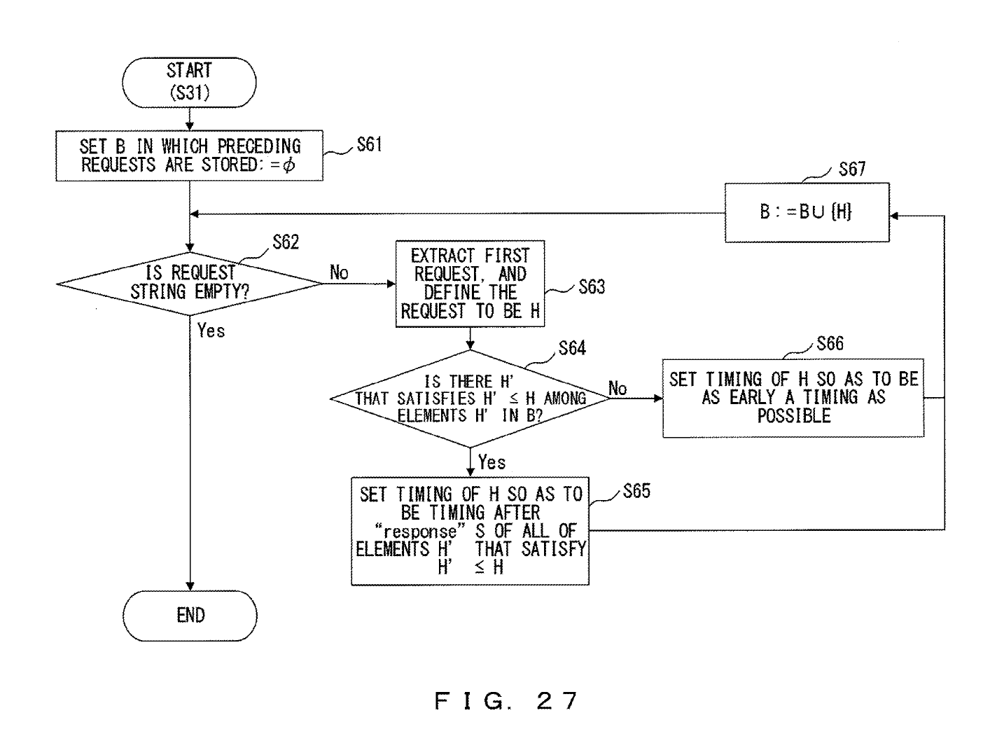

FIG. 27 illustrates a flow of determining a request-issuing timing according to the embodiment (Example 2). The flow of FIG. 27 is a detailed flow of FIG. 4, and is a flow that corresponds to FIG. 18.

The reproduction time determination unit 24 initializes the set B in which preceding requests are stored to an empty set (φ) (S61).

The constraint extraction unit 23 determines whether a request string is empty (S62). Here, the request string is “request 1 (H1), request 2 (H2), request 3 (H3), request 4 (H4)” in the case of FIG. 18.

When the request string is not empty (“No” in S62), the constraint extraction unit 23 extracts the first request H from the request string (S63). When an H′ that satisfies H′≦H exists among elements H′ included in B (“Yes” in S64), the constraint extraction unit 23 sets a timing of H so as to be a timing after “response”s of all of the elements H′ that satisfy H′≦H (S65).

When an H′ that satisfies H′≦H does not exist among the elements H′ included in B (“No” in S64), the constraint extraction unit 23 sets a timing of H so as to be as early a timing as possible (such as a head timing, or as long as the order of requests is stored) (S66).

After the process of S65 or S66, the union of B and {H} is stored in B (S67).

The processes of S63 to S67 are repeated until the request string becomes empty. When the request string becomes empty (“Yes” in S62), this flow is finished.

As a result, parallel processing can be performed, and therefore a load on an access reproduction device can be reduced. In addition, only a desired portion can be executed, and therefore undesired tests can be deleted.

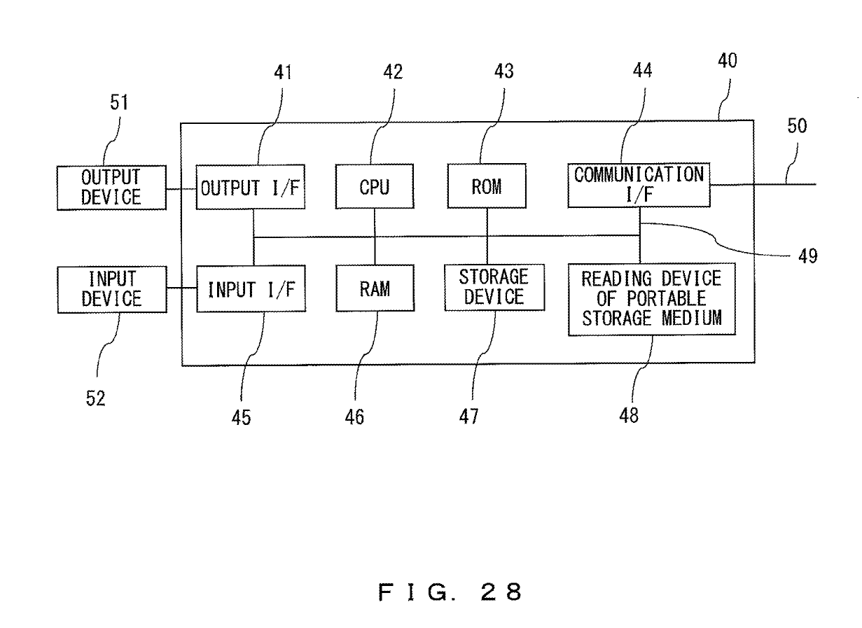

FIG. 28 illustrates an example of a configuration block diagram of a hardware environment of a computer that executes a program according to the embodiment. A computer 40 functions as the timing determination device 11. The computer 40 is configured of a CPU 42, a ROM 43, a RAM 46, a communication I/F 44, a storage device 47, an output I/F 41, an input I/F 45, a reading device 48, a bus 89, an output device 51, and an input device 52.

Here, the CPU indicates a central processing unit. The ROM indicates a read only memory. The RAM indicates a random access memory. The I/F indicates an interface. To the bus 49, the CPU 42, the ROM 43, the RAM 46, the communication I/F 44, the storage device 47, the output I/F 41, the input I/F 45, and the reading device 48 are connected. The reading device 48 is a device that reads a portable recording medium. The output device 51 is connected to the output I/F 41. The input device 52 is connected to the input I/F 45.

Various types of storage devices, such as a hard disk, a flash memory, or a magnetic disk, can be used for the storage device 47. In the storage device 47 or the ROM 43, a program for causing the CPU 42 to function as the constraint extraction unit 23 and the reproduction time determination unit 24 is stored. In addition, in the storage device 47 or the ROM 43, the capture data 25 read from the storage device 5, or the reproduction time information 26 is stored. In the RAM 46, constraint information is temporarily stored.

The CPU 42 reads a program for realizing a process described in the embodiment above, which has been stored in the storage device 47 or the like, and executes the program.

The program for realizing the process described in the embodiment above may be stored in, for example, the storage device 47 via a communication network 50 and the communication I/F 44 from a program provider. The program for realizing the process described in the embodiment above may also be stored in a portable storage medium that is commercially available and is distributed. In this case, the portable storage medium may be provided in the reading device 48, and the program stored therein may be read and executed by the CPU 42. Various types of storage mediums, such as a CD-ROM, a flexible disk, an optical disk, a magneto-optical disk, an IC card, or a USB memory device, may be used for the portable storage medium. A program stored in the storage medium as described above is read by the reading device 48.

In addition, a keyboard, a mouse, an electronic camera, a web camera, a microphone, a scanner, a sensor, a tablet, or the like can be used for the input device 52. A display, a printer, a speaker, or the like can be used for the output device 51. The network 50 may be a communication network such as the internet, a LAN, a WAN, a dedicated line, a wired network, a wireless network, or the like.

According to an aspect of the embodiments, request information can be transmitted to a multi-tier information processing system taking into consideration an order in a plurality of tiers.

The present invention is not limited to the embodiment above, and can have various configurations or embodiments without departing from the spirit of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a determining process for determining a transmission order, the process comprising:
obtaining communication information that is transmitted/received between tiers in an information processing system constructed of a plurality of tiers, the information processing system providing a result of a process performed in an n-th (n>2) tier in reply to received request information;
identifying pairs of the request information and response information corresponding to the request information in each of the plurality of tiers from the obtained communication information;
comparing the pairs in each of the plurality of tiers;
extracting an order relationship wherein the request information of a second pair is transmitted after the response information of a first pair is obtained;
obtaining the order relationship in an (n-i)th (i=1, 2, . . . , n-1) tier on the basis of the order relationship between the pairs in an (n-i+1)th tier that respectively correspond to the pairs in the (n-i)th tier, sequentially from the n-th tier to a first tier; and
determining the transmission order of the request information to the information processing system on the basis of the obtained order relationship.

2. The non-transitory computer-readable recording medium according to claim 1, wherein
the extracting extracts the order relationship on the basis of pieces of the request information that requests updating of the same data region in the n-th tier when the n-th tier is a tier in which data has been stored.

3. The non-transitory computer-readable recording medium according to claim 1, wherein
the extracting does not set an order for continuous pieces of reading request information from among pieces of the reading request information that requests reading from the same data region in the n-th tier when the n-th tier is a tier in which data has been stored.

4. The non-transitory computer-readable recording medium according to claim 1, wherein
the obtaining the order relationship includes
extracting the order relationship between the pairs in the (n-i)th tier in accordance with the order relationship between the pairs in the (n-i+1)th tier that respectively correspond to the pairs in the (n-i)th tier when the pairs to be compared in the (n-i)th tier have the order relationship;
extracting the order relationship between the pairs in the (n-i)th tier in accordance with the order relationship between the pairs in the (n-i+1)th tier when the pairs to be compared in the (n-i)th tier do not have the order relationship and when the pairs in the (n-i+1)th tier that respectively correspond to the pairs in (n-i)th tier have the order relationship; and
maintaining the order relationship of the pairs to be compared in the (n-i)th tier when the pairs to be compared in the (n-i)th tier do not have the order relationship, and when, comparing the pairs in the (n-i+1)th tier that respectively correspond to the pairs in the (n-i)th tier, from among the compared pairs in the (n-i+1)th tier, one of the request information and the response information of a third pair is transmitted or received before one of the request information and the response information of a fourth pair is transmitted or received, and one of the request information and the response information of a fifth pair is transmitted or received after one of the request information and the response information of the fourth pair is transmitted or received.

5. The non-transitory computer-readable recording medium according to claim 1, the process further comprising:
outputting timing information for transmitting the request information to the information processing system on the basis of the determined transmission order.

6. A transmission order determination device comprising:
a memory; and
a controller that performs a process including:
obtaining communication information that is transmitted/received between tiers in an information processing system constructed of a plurality of tiers, the information processing system providing a result of a process performed in an n-th (n≧2) tier in reply to received request information;
identifying pairs of the request information and response information corresponding to the request information in each of the plurality of tiers from the obtained communication information;
comparing the pairs in each of the plurality of tiers;
extracting an order relationship wherein the request information of a second pair is transmitted after the response information of a first pair is obtained; and
obtaining the order relationship in an (n-i)th (i=1, 2, . . . , n-1) tier on the basis of the order relationship between the pairs in an (n-i+1)th tier that respectively correspond to the pairs in the (n-i)th tier, sequentially from the n-th tier to a first tier; and
determining a transmission order of the request information to the information processing system on the basis of the obtained order relationship.

7. The transmission order determination device according to claim 6, wherein
the extracting extracts the order relationship on the basis of pieces of the request information that requests updating of the same data region in the n-th tier when the n-th tier is a tier in which data has been stored.

8. The transmission order determination device according to claim 6, wherein
the extracting does not set an order of continuous pieces of reading request information from among pieces of the reading request information that requests reading from the same data region in the n-th tier when the n-th tier is a tier in which data has been stored.

9. The transmission order determination device according to claim 6, wherein
the obtaining the order relationship includes
extracting the order relationship between the pairs in the (n-i)th tier in accordance with the order relationship between the pairs in the (n-i+1)th tier that respectively correspond to the pairs in the (n-i)th tier, when the pairs to be compared in the (n-i)th tier have the order relationship;
extracting the order relationship between the pairs in the (n-i)th tier in accordance with the order relationship between the pairs in the (n-i+1)th tier when the pairs to be compared in the (n-i)th tier do not have the order relationship and when the pairs in the (n-i+1)th tier that respectively correspond to the pairs in (n-i)th tier have the order relationship; and
maintaining the order relationship of the pairs to be compared in the (n-i)th tier, when the pairs to be compared in the (n-i)th tier do not have the order relationship, and when, comparing the pairs in the (n-i+1)th tier that respectively correspond to the pairs in the (n-i)th tier, from among the compared pairs in the (n-i+1)th tier, one of the request information and the response information of a third pair is transmitted or received before one of the request information and the response information of a fourth pair is transmitted or received, and one of the request information and the response information of a fifth pair is transmitted or received after one of the request information and the response information of the fourth pair is transmitted or received.

10. The transmission order determination device according to claim 6, wherein the process further including
outputting timing information for transmitting the request information to the information processing system on the basis of the determined transmission order.

11. A transmission order determination method comprising:
obtaining, by a computer, communication information that is transmitted/received between tiers in an information processing system constructed of a plurality of tiers, the information processing system providing a result of a process performed in an n-th (n>2) tier in reply to received request information;
identifying, by the computer, pairs of the request information and response information corresponding to the request information in each of the plurality of tiers from the obtained communication information;
comparing, by the computer, the pairs in each of the plurality of tiers;
extracting, by the computer, an order relationship wherein the request information of a second pair is transmitted after the response information of a first pair is obtained;
obtaining, by the computer, the order relationship in an (n-i)th (i=1, 2, . . . , n-1) tier on the basis of the order relationship between the pairs in an (n-i+1)th tier that respectively correspond to the pairs in the (n-i)th tier, sequentially from the n-th tier to a first tier; and
determining, by the computer, the transmission order of the request information to the information processing system on the basis of the extracted order relationship.

12. The transmission order determination method according to claim 11, wherein
the extracting extracts the order relationship on the basis of pieces of the request information that requests updating of the same data region in the n-th tier when the n-th tier is a tier in which data has been stored.

13. The transmission order determination method according to claim 11, wherein
the extracting does not set an order for continuous pieces of reading request information from among pieces of the reading request information that requests reading from the same data region in the n-th tier when the n-th tier is a tier in which data has been stored.

14. The transmission order determination method according to claim 11, wherein
the obtaining the order relationship includes
extracting the order relationship between the pairs in the (n-i)th tier in accordance with the order relationship between the pairs in the (n-i+1)th tier when the pairs to be compared in the (n-i)th tier have the order relationship;
extracting the order relationship between the pairs in the (n-i)th tier in accordance with the order relationship between the pairs in the (n-i+1)th tier when the pairs to be compared in the (n-i)th tier do not have the order relationship, and when the pairs in the (n-i+1)th tier that respectively correspond to the pairs in (n-i)th tier have the order relationship; and
maintaining the order relationship of the pairs to be compared in the (n-i)th tier when the pairs to be compared in the (n-i)th tier do not have the order relationship, and when, comparing the pairs in the (n-i+1)th tier that respectively correspond to the pairs in the (n-i)th tier, from among the compared pairs in the (n-i+1)th tier, one of the request information and the response information of a third pair is transmitted or received before one of the request information and the response information of a fourth pair is transmitted or received, and one of the request information and the response information of a fifth pair is transmitted or received after one of the request information and the response information of the fourth pair is transmitted or received.

15. The transmission order determination method according to claim 11, the transmission order determination method further comprising:
outputting, by the computer, timing information for transmitting the request information to the information processing system on the basis of the determined transmission order.
